(19) United States
(12) Patent Application Publication
(10) Pub. No.: US 2023/0403646 A1
(43) Pub. Date: Dec. 14, 2023

(54) SCG ACTIVATION DURING MOBILITY

(71) Applicant: Telefonaktiebolaget LM Ericsson (publ), Stockholm (SE)

(72) Inventors: Pontus WALLENTIN, Linköping (SE); Jens BERGQVIST, Linköping (SE); Icaro Leonardo DA SILVA, Solna (SE)

(21) Appl. No.: 18/032,290

(22) PCT Filed: Oct. 21, 2021
(86) PCT No.: PCT/SE2021/051054

§ 371 Date: Apr. 17, 2023

Related U.S. Application Data
(60) Provisional application No. 63/104,428, filed on Oct. 22, 2020.

(51) Int. Cl. H04W 52/02; H04W 74/08; H04W 36/00; H04W 36/16

(52) U.S. Cl. CPC H04W 52/0212; H04W 74/0833; H04W 36/0069; H04W 36/165

(57) ABSTRACT

A method, performed by a communication device operating in dual connectivity with a master cell group, MCG, and a secondary cell group, SCG, of a wireless communication network includes receiving a message from a network node of the wireless communication network, the message including an instruction to perform a mobility procedure concerning at least one of the MCG or the SCG, determining an SCG state for power saving for the communication device, executing the mobility procedure according to the instruction and the SCG state, and applying the determined SCG state following execution of the mobility procedure.

### TECHNICAL FIELD

The present disclosure relates generally to communications, and more particularly to communication methods and related devices and nodes supporting wireless communications.

### BACKGROUND

When CA is configured, the UE only has one RRC connection with the network. Further, at RRC connection establishment/re-establishment/handover, one serving cell provides the NAS mobility information, and at RRC connection re-establishment/handover, one serving cell provides the security input. This cell is referred to as the Primary Cell (PCell). In addition, depending on UE capabilities, Secondary Cells (SCells) can be configured to form together with the PCell a set of serving cells. The configured set of serving cells for a UE therefore always consists of one PCell and one or more SCells. Further, when dual connectivity is configured, it could be the case that one carrier under the SCG is used as the Primary SCell (PSCell). Hence, in this case we have one PCell and one or more SCell(s) over the MCG and one PSCell and one or more SCell(s) over the SCG.

The reconfiguration, addition and removal of SCells can be performed by RRC. At intra-RAT handover, RRC can also add, remove, or reconfigure SCells for usage with the target PCell. When adding a new SCell, dedicated RRC signaling is used for sending all required system information of the SCell i.e. while in connected mode, UEs need not acquire broadcasted system information directly from the SCells.

In 3GPP the dual-connectivity (DC) solution has been specified, both for LTE and between LTE and NR. In DC two nodes are involved, a master node (MN or MeNB) and a Secondary Node (SN, or SeNB). Multi-connectivity (MC) is the case when there are more than 2 nodes involved. Also, it has been proposed in 3GPP that DC is used in the Ultra Reliable Low Latency Communications (URLLC) cases in order to enhance the robustness and to avoid connection interruptions.

There are different ways to deploy 5G network with or without interworking with LTE (also referred to as E-UTRA) and evolved packet core (EPC), as depicted in Error! Reference source not found. In principle, NR and LTE can be deployed without any interworking, denoted by NR stand-alone (SA) operation, that is gNB in NR can be connected to 5G core network (5GC) and eNB can be connected to EPC with no interconnection between the two (Option 1 and Option 2 in the figure). On the other hand, the first supported version of NR is the so-called EN-DC (E-UTRAN-NR Dual Connectivity), illustrated by Option 3. In such a deployment, dual connectivity between NR and LTE is applied with LTE as the master and NR as the secondary node. The RAN node (gNB) supporting NR, may not have a control plane connection to core network (EPC), instead it relies on the LTE as master node (MeNB). This is also called as “Non-standalone NR”. Notice that in this case the functionality of an NR cell is limited and would be used for connected mode UEs as a booster and/or diversity leg, but an RRC IDLE UE cannot camp on these NR cells.

With introduction of 5GC, other options may be also valid. As mentioned above, option 2 supports stand-alone NR deployment where gNB is connected to 5GC. Similarly, LTE can also be connected to 5GC using option 5 (also known as eLTE, E-UTRA/SGC, or LTE/5GC and the node can be referred to as an ng-eNB). In these cases, both NR and LTE are seen as part of the NG-RAN (and both the ng-eNB and the gNB can be referred to as NG-RAN nodes). It is worth noting that, Option 4 and option 7 are other variants of dual connectivity between LTE and NR which will be standardized as part of NG-RAN connected to 5GC, denoted by MR-DC (Multi-Radio Dual Connectivity). Under the MR-DC umbrella, we have:
EN-DC (Option 3): LTE is the master node and NR is the secondary (EPC CN employed)
NE-DC (Option 4): NR is the master node and LTE is the secondary (SGCN employed)
NGEN-DC (Option 7): LTE is the master node and NR is the secondary (SGCN employed)
NR-DC (variant of Option 2): Dual connectivity where both the master and secondary are NR (SGCN employed).

As migration for these options may differ from different operators, it is possible to have deployments with multiple options in parallel in the same network e.g. there could be eNB base station supporting option 3, 5 and 7 in the same network as NR base station supporting 2 and 4. In combination with dual connectivity solutions between LTE and NR it is also possible to support CA (Carrier Aggregation) in each cell group (i.e. MCG and SCG) and dual connectivity between nodes on same RAT (e.g. NR-NR DC). For the LTE cells, a consequence of these different deployments is the co-existence of LTE cells associated to eNBs connected to EPC, 5GC or both EPC/5GC.

As said earlier, DC is standardized for both LTE and E-UTRA -NR DC (EN-DC). LTE DC and EN-DC are designed differently when it comes to which nodes control what. Basically, there are two options:
Centralized solution (like LTE-DC),
Decentralized solution (like EN-DC).

FIG. 2 shows the schematic control plane architecture looks like for dual connectivity in LTE DC and EN-DC. The main difference here is that in EN-DC, the SN has a separate RRC entity (NR RRC). This means that the SN can control the UE also; sometimes without the knowledge of the MN but often the SN need to coordinate with the MN. In LTE-DC, the RRC decisions are always coming from the MN (MN to UE). Note however, the SN still decides the configuration of the SN, since it is only the SN itself that has knowledge of what kind of resources, capabilities etc. the SN has.

For EN-DC, the major changes compared to LTE DC are:
The introduction of split bearer from the SN (known as SCG split bearer)
The introduction of split bearer for RRC
The introduction of a direct RRC from the SN (also referred to as SCG SRB)

FIG. 3 illustrates network side protocol termination options for MCG, SCG, and split bearers in MR-DC with EPC (EN-DC). FIG. 4 illustrates network architecture for control plane in EN-DC. FIGS. 3 and 4 also show the UP and Control Plane (CP) architectures for EN-DC.

The SN is sometimes referred to as SgNB (where gNB is an NR base station), and the MN as MeNB in case the LTE is the master node and NR is the secondary node. In the other case where NR is the master and LTE is the secondary node, the corresponding terms are SeNB and MgNB.

Split RRC messages are mainly used for creating diversity, and the sender can decide to either choose one of the links for scheduling the RRC messages, or it can duplicate the message over both links. In the downlink, the path switching between the MCG or SCG legs or duplication on both is left to network implementation. On the other hand, for the UL, the network configures the UE to use the MCG, SCG or both legs. The terms “leg”, “path” and “RLC bearer” are used interchangeably throughout the present disclosure.

In order to improve network energy efficiency and UE battery life for UEs in MR-DC, a Rel-17 work item is planned to introduce efficient SCG/SCell activation/deactivation for SCG power saving mode. This can be especially important for MR-DC configurations with NR SCG, as it has been evaluated in RP-190919 that in some cases NR UE power consumption is 3 to 4 times higher than LTE.

3GPP has specified the concepts of dormant SCell (in LTE) and dormancy like behavior of an SCell (for NR). In LTE, when an S Cell is in dormant state, like in the deactivate state, the UE does not need to monitor the corresponding PDCCH or PDSCH and cannot transmit in the corresponding uplink. However, differently from deactivated state, the UE is required to perform and report CQI measurements. A PUCCH SCell (SCell configured with PUCCH) cannot be in dormant state.

In NR, dormancy like behavior for SCells is realized using the concept of dormant BWPs as shown in FIG. 5. One dormant BWP, which is one of the dedicated BWPs configured by the network via RRC signaling, can be configured for an S Cell. If the active BWP of the activated S Cell is a dormant BWP, the UE stops monitoring PDCCH on the SCell but continues performing CSI measurements, AGC and beam management, if configured. A DCI is used to control entering/leaving the dormant BWP for one or more SCell(s) or one or more SCell group(s), and it is sent to the special cell (sPCell) of the cell group that the SCell belongs to (i.e. PCell in case the SCell belongs to the MCG and PSCell if the SCell belongs to the SCG). The SpCell (i.e. PCell of PSCell) and PUCCH SCell cannot be configured with a dormant BWP.

However, only SCells can be put to put in dormant state (in LTE) or operate in dormancy like behavior (NR). Also, only SCells can be put into the deactivated state in both LTE and NR. Thus, if the UE is configured with MR-DC, it is not possible to fully benefit from the power saving options of dormant state or dormancy like behavior as the PSCell cannot be configured with that feature. Instead, an existing solution could be releasing (for power savings) and adding (when traffic demands requires) the SCG on a need basis. However, traffic is likely to be burst-y, and adding and releasing the SCG involves a significant amount of RRC signaling and inter-node messaging between the MN and the SN, which causes considerable delay.

In rel-16, some discussions were made regarding putting also the PSCell in dormancy, also referred to as SCG Suspension. Some preliminary agreements were made in RAN2-107bis, October 2019 (see chairman notes at R2-1914301):

R2 assumes the following (can be slightly modified due to progress on Scell dormancy):
⇒ The UE supports network-controlled suspension of the SCG in RRC CONNECTED.
⇒UE behavior for a suspended SCG is FFS
⇒ The UE supports at most one SCG configuration, suspended or not suspended, in Re116.
⇒ In RRC CONNECTED upon addition of the SCG, the SCG can be either suspended or not suspended by configuration.

In RAN2-108, further discussion was made to clarify the above FFSs. Some solutions have been proposed in Rel-16, but these have different problems. For example, in R2-1908679 (Introducing suspension of SCG—Qualcomm) the paper proposes that gNB can indicate UE to suspend SCG transmissions when no data traffic is expected to be sent in SCG so that UE keeps the SCG configuration but does not use it for power saving purpose. Therein, it is mentioned that signaling to suspend SCG could be based on DCI/MAC-CE/RRC signaling, but no details were provided regarding the configuration from the gNB to the UE. And, differently from the defined behavior for SCell(s), PSCell(s) may be associated to a different network node (e.g. a gNodeB operating as Secondary Node).

### SUMMARY

A method, performed by a communication device operating in dual connectivity with a master cell group, MCG, and a secondary cell group, SCG, of a wireless communication network according to some embodiments is provided. The method includes receiving a message from a network node of the wireless communication network, the message including an instruction to perform a mobility procedure concerning at least one of the MCG or the SCG, determining an SCG state for power saving for the communication device, executing the mobility procedure according to the instruction and according to the determined SCG state for power saving, and applying the determined SCG state for power saving following execution of the mobility procedure.

In some embodiments, the mobility procedure includes MCG mobility from a source MCG, controlled by a source master node, MN, to a target MCG controlled by a target MN.

In some embodiments, the mobility procedure includes SCG mobility from a source SCG controlled by a source secondary node, SN, to a target SCG controlled by a target SN.

In some embodiments, in response to determining that the SCG state for power saving is an SCG activated state, the communication device performs a random access to a target cell.

In some embodiments, determining the SCG state for power saving includes determining an SCG activated state in response to an instruction to perform an MCG mobility procedure or an SCG mobility procedure.

In some embodiments, determining the SCG state for power saving includes determining the SCG state for power saving based on a determination that the SCG state for power saving is to remain the same as before the mobility procedure was executed.

A communication device according to some embodiments includes processing circuitry, and memory coupled with the processing circuitry, wherein the memory includes instructions that when executed by the processing circuitry causes the communication device to perform operations according to any of the foregoing embodiments.

A communication device according to some embodiments is adapted to perform according to any of the foregoing embodiments.

A computer program including program code to be executed by processing circuitry of a communication device, whereby execution of the program code causes the communication device to perform operations according to any of the foregoing embodiments.

A computer program product including a non to transitory storage medium including program code to be executed by processing circuitry of a communication device, whereby execution of the program code causes the communication device to perform operations according to any of the foregoing embodiments.

Some embodiments provide a method, performed by a target network node configured to control a target cell group used by a communication device operating in dual connectivity with a master cell group, MCG, and a secondary cell group, SCG, of a wireless communication network. The method includes determining a need of the communication device to perform a mobility procedure to the target cell group, determining an SCG state for power saving for the communication device, preparing a message with an instruction for a communication device to perform the mobility procedure, and transmitting the message to a source network node.

In some embodiments, the message includes an indication of the SCG state for power saving.

In some embodiments, determining the need to perform the mobility procedure to the target cell group includes determining the need to perform the mobility procedure to the target cell group based on a source network node initiating a mobility preparation procedure.

In some embodiments, determining the need to perform the mobility procedure to the target cell group includes determining the need to perform the mobility procedure to the target cell group based on when a third node triggers a mobility preparation procedure. In some embodiments, the third node includes a master node.

In some embodiments, determining the SCG state for power saving includes determining an SCG activated state in response to execution of an MCG mobility procedure or an SCG mobility procedure.

In some embodiments, determining the SCG state for power saving includes determining an SCG activated state in response to reception of a message from the communication device during the mobility procedure.

In some embodiments, the message from the communication device includes an indication of the SCG state for power saving in one of a field or an information element of the message.

A method according to further embodiments is performed by a master node, MN, controlling a master cell group, MCG, of a wireless communication network. The MN is configured to communicate with a communication device operating in dual connectivity with the MCG and with a secondary cell group, SCG, of a wireless communication network. The method includes determining a need for the communication device to perform a mobility procedure concerning the SCG, receiving a message from a target secondary node with an instruction for the communication device to perform the mobility procedure, transmitting the message to the communication device, determining an SCG state for power saving for the communication device, and applying the determined SCG state.

In some embodiments, the mobility procedure includes SCG mobility from a source SCG controlled by a source secondary node, SN, to a target SCG controlled by a target secondary node, SN,

In some embodiments, determining the need for the communication device to perform the mobility procedure includes determining the need for the communication device to perform the mobility procedure concerning the SCG based on measurement reports received from the communication device.

In some embodiments, determining the need for the communication device to perform the mobility procedure includes determining the need for the communication device to perform the mobility procedure concerning the SCG when a third node triggers the mobility procedure. In some embodiments, the third node includes a secondary node.

In some embodiments, the message includes a Radio Resource Control, RRC, message.

In some embodiments, determining the SCG state for power saving for the communication device includes determining an SCG activated state for the communication device in response to execution of the mobility procedure.

In some embodiments, determining the SCG state for power saving for the communication device includes determining an SCG activated state for the communication device in response to one of reception of a message from the communication device during the mobility procedure or an indication that the mobility procedure was initiated by one of the master node or the secondary node.

In some embodiments, the indication is received from a target network node during the mobility procedure.

A method, performed by a secondary node, SN, controlling a secondary cell group, SCG, of a wireless communication network is provided. The SN is configured to communicate with a communication device operating in dual connectivity with the SCG and a master cell group, MCG, of a wireless communication network. The method includes determining an SCG state for power saving for the communication device in connection with a mobility procedure involving the communication device, and applying the determined SCG state for power saving for the communication device.

In some embodiments, the mobility procedure is concerning the MCG, and the method further includes receiving a message from a network node during the mobility procedure concerning the MCG.

In some embodiments, determining the SCG state for power saving includes determining the SCG state for power saving in response to receiving the message from the network node during the mobility procedure concerning the MCG.

In some embodiments, the network node includes one of a source master node, MN, or a target MN.

In some embodiments, the mobility procedure includes MCG mobility from a source MCG controlled by a source master node, MN, to a target MCG controlled by a target master node, MN.

In some embodiments, the message includes an indication of a SCG power state for power saving.

In some embodiments, determining the SCG state for power saving includes determining the SCG state based on the indication of the message.

In some embodiments, determining the SCG state for power saving includes determining an SCG activated state.

The method may further include receiving a message from the communication device indicating the communication device performs random access to the SN.

In some embodiments, determining the SCG state for power saving includes determining the SCG state to be an SCG activated state based on the message from the communication device indicating the communication device performs random access to the SN.

A radio access network, RAN, node according to some embodiments includes processing circuitry, and memory coupled with the processing circuitry, wherein the memory includes instructions that when executed by the processing circuitry causes the RAN node to perform operations according to any of the foregoing embodiments.

A radio access network, RAN, node according to some embodiments is adapted to perform according to any of the foregoing embodiments.

A computer program according to some embodiments includes program code to be executed by processing circuitry of a radio access network, RAN, node, whereby execution of the program code causes the RAN node to perform operations according to any of the foregoing embodiments.

A computer program product according to some embodiments includes a non to transitory storage medium including program code to be executed by processing circuitry of a radio access network, RAN, node, whereby execution of the program code causes the RAN node to perform operations according to any of the foregoing embodiments.

Some embodiments described herein may allow MCG mobility and SCG mobility while the SCG is in a power saving state, also known as deactivated state or suspended state. More specifically, some embodiments enable a UE to determine the SCG state for power saving (as either SCG activated state or SCG deactivated state) as result of the MCG or SCG mobility procedure, thereby enhancing power savings.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a diagram illustrating LTE and NR interworking options;

FIG. 2 is a block diagram illustrating control plane architecture for dual connectivity in LTE DC and EN-DC;

FIG. 3 is a diagram illustrating Network side protocol termination options for MCG, SCG and split bearers in MR-DC with EPC (EN-DC);

FIG. 4 is a diagram illustrating network architecture for control plane in EN-DC;

FIG. 5 is a diagram illustrating dormancy like behavior for SCells in NR;

FIG. 6 is a signal diagram illustrating legacy Rel-15 NR handover;

FIG. 7 is a signal diagram illustrating an Inter-MN handover with/without MN initiated SN change procedure according to some embodiments of inventive concepts;

FIG. 8 is a signal diagram illustrating a MN to ng-eNB/gNB change procedure according to some embodiments of inventive concepts;

FIG. 9 is a signal diagram illustrating a ng-eNB/gNB to MN change procedure according to some embodiments of inventive concepts;

FIG. 10 is a signal diagram illustrating a SN initiated SN Modification without MN involvement according to some embodiments of inventive concepts;

FIG. 11 is a signal diagram illustrating SN initiated SN Modification with MN involvement according to some embodiments of inventive concepts;

FIG. 12 is a signal diagram illustrating a MN initiated SN change procedure according to some embodiments of inventive concepts;

FIG. 13 is a signal diagram illustrating a SN initiated SN change procedure according to some embodiments of inventive concepts;

FIG. 14 is a flow diagram illustrating operations of a UE according to some embodiments of inventive concepts;

FIG. 15 is a flow diagram illustrating operations of a target network node according to some embodiments of inventive concepts;

FIG. 16 is a flow diagram illustrating operations of a master node (MN) according to some embodiments of inventive concepts;

FIG. 17 is a flow diagram illustrating operations of a secondary node (SN) according to some embodiments of inventive concepts;

FIG. 18 is a signal diagram illustrating an example signaling flow for an Inter-MN handover with/without MN initiated SN change procedure according to some embodiments of inventive concepts;

FIG. 19 is a signal diagram illustrating an example signaling flow for an SN change procedure initiated by the MN according to some embodiments of inventive concepts;

FIG. 20 is a signal diagram illustrating an example signaling flow for an SN change procedure initiated by the SN according to some embodiments of inventive concepts;

FIG. 21 is a block diagram illustrating a communication device UE according to some embodiments of inventive concepts;

FIG. 22 is a block diagram illustrating a radio access network RAN node (e.g., a base station eNB/gNB) according to some embodiments of inventive concepts;

FIG. 23 is a block diagram illustrating a core network CN node (e.g., an AMF node, an SMF node, etc.) according to some embodiments of inventive concepts;

FIG. 24 is a flow chart illustrating operations of a communication device according to some embodiments of inventive concepts;

FIG. 25 is a flow chart illustrating operations of a target network node according to some embodiments of inventive concepts;

FIG. 26 is a flow chart illustrating operations of a master node according to some embodiments of inventive concepts;

FIG. 27 is a flow chart illustrating operations of a secondary node according to some embodiments of inventive concepts;

FIG. 28 is a block diagram of a wireless network in accordance with some embodiments;

FIG. 29 is a block diagram of a user equipment in accordance with some embodiments

FIG. 30 is a block diagram of a virtualization environment in accordance with some embodiments;

FIG. 31 is a block diagram of a telecommunication network connected via an intermediate network to a host computer in accordance with some embodiments;

FIG. 32 is a block diagram of a host computer communicating via a base station with a user equipment over a partially wireless connection in accordance with some embodiments;

FIG. 33 is a block diagram of methods implemented in a communication system including a host computer, a base station and a user equipment in accordance with some embodiments;

FIG. 34 is a block diagram of methods implemented in a communication system including a host computer, a base station and a user equipment in accordance with some embodiments;

FIG. 35 is a block diagram of methods implemented in a communication system including a host computer, a base station and a user equipment in accordance with some embodiments; and

FIG. 36 is a block diagram of methods implemented in a communication system including a host computer, a base station and a user equipment in accordance with some embodiments.

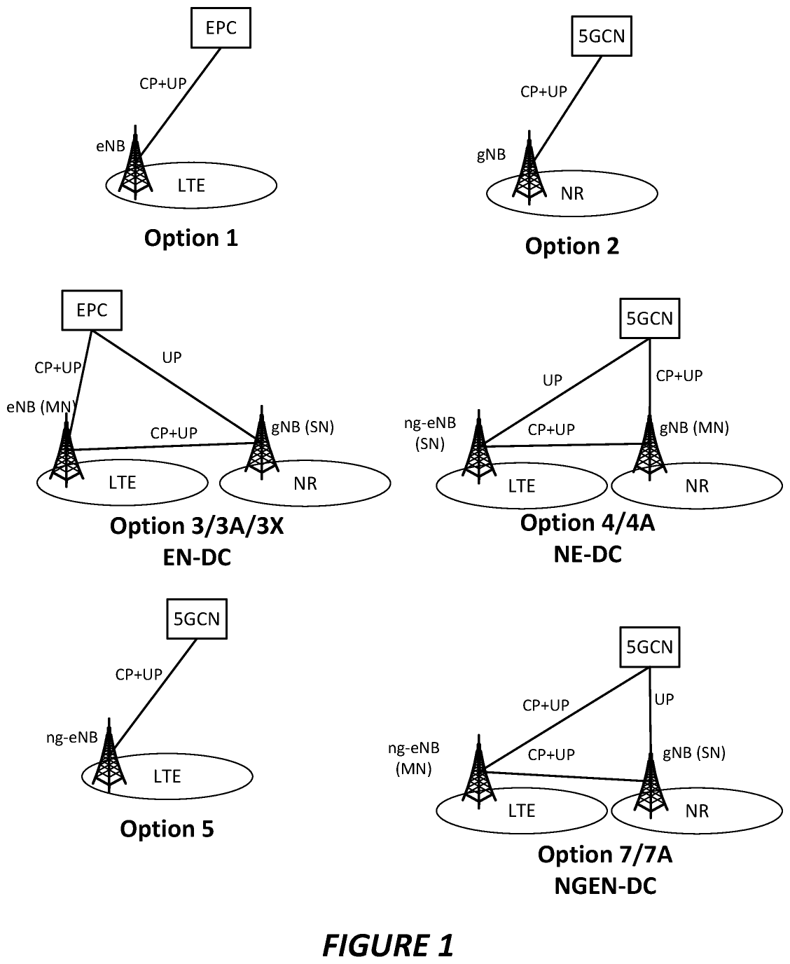

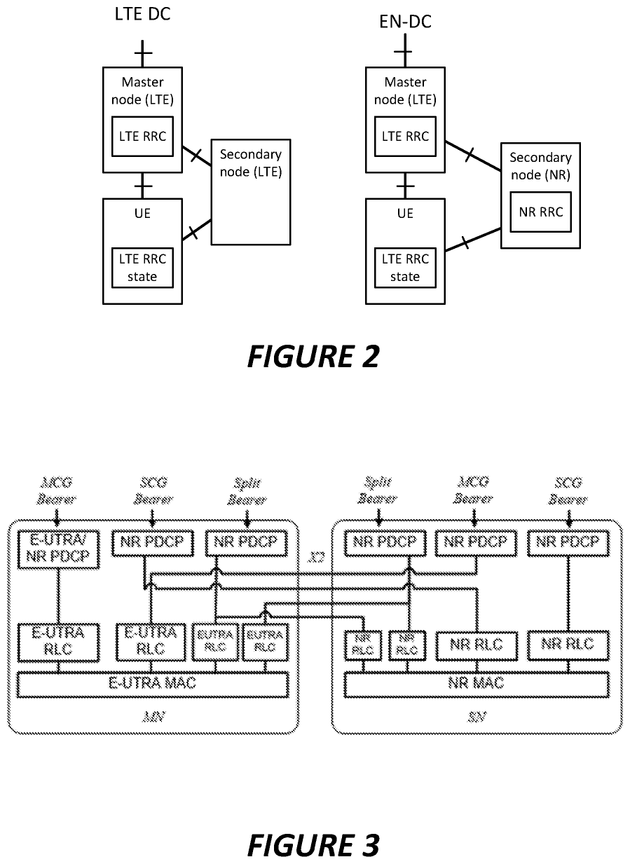

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

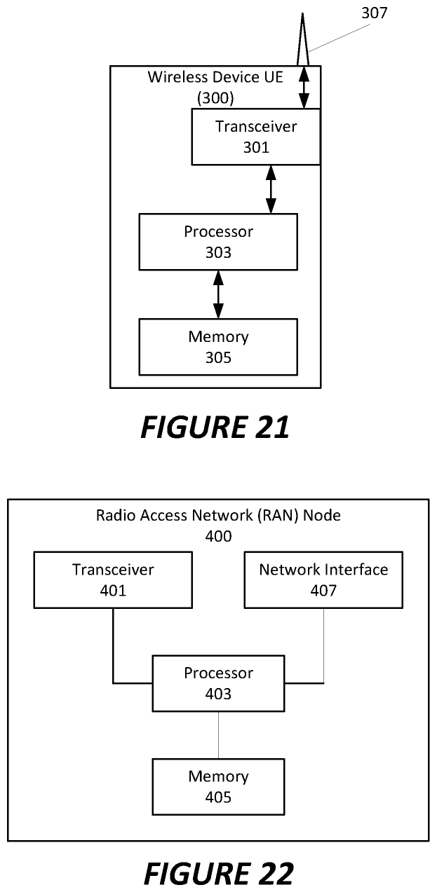

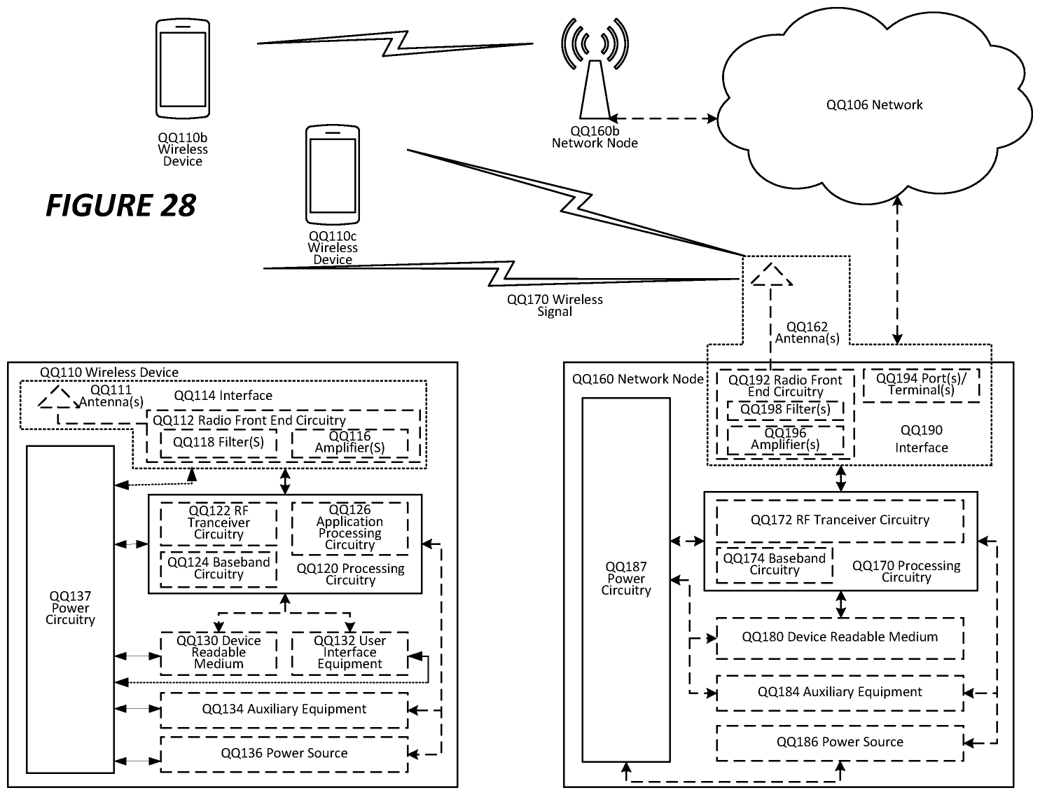

FIG. 21 is a block diagram illustrating elements of a communication device UE 300 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 300 may be provided, for example, as discussed below with respect to wireless device 4110 of FIG. 28.) As shown, communication device UE may include an antenna 307 (e.g., corresponding to antenna 4111 of FIG. 28), and transceiver circuitry 301 (also referred to as a transceiver, e.g., corresponding to interface 4114 of FIG. 28) including a transmitter and a receiver configured to provide uplink and downlink radio communications with a base station(s) (e.g., corresponding to network node 4160 of FIG. 28, also referred to as a RAN node) of a radio access network. Communication device UE may also include processing circuitry 303 (also referred to as a processor, e.g., corresponding to processing circuitry 4120 of FIG. 28) coupled to the transceiver circuitry, and memory circuitry 305 (also referred to as memory, e.g., corresponding to device readable medium 4130 of FIG. 28) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that separate memory circuitry is not required. Communication device UE may also include an interface (such as a user interface) coupled with processing circuitry 303, and/or communication device UE may be incorporated in a vehicle.

As discussed herein, operations of communication device UE may be performed by processing circuitry 303 and/or transceiver circuitry 301. For example, processing circuitry 303 may control transceiver circuitry 301 to transmit communications through transceiver circuitry 301 over a radio interface to a radio access network node (also referred to as a base station) and/or to receive communications through transceiver circuitry 301 from a RAN node over a radio interface. Moreover, modules may be stored in memory circuitry 305, and these modules may provide instructions so that when instructions of a module are executed by processing circuitry 303, processing circuitry 303 performs respective operations (e.g., operations discussed below with respect to Example Embodiments relating to wireless communication devices).

FIG. 22 is a block diagram illustrating elements of a radio access network RAN node 400 (also referred to as a network node, base station, eNodeB/eNB, gNodeB/gNB, etc.) of a Radio Access Network (RAN) configured to provide cellular communication according to embodiments of inventive concepts. (RAN node 400 may be provided, for example, as discussed below with respect to network node 4160 of FIG. 28.) As shown, the RAN node may include transceiver circuitry 401 (also referred to as a transceiver, e.g., corresponding to portions of interface 4190 of FIG. 28) including a transmitter and a receiver configured to provide uplink and downlink radio communications with mobile terminals. The RAN node may include network interface circuitry 407 (also referred to as a network interface, e.g., corresponding to portions of interface 4190 of FIG. 28) configured to provide communications with other nodes (e.g., with other base stations) of the RAN and/or core network CN. The network node may also include processing circuitry 403 (also referred to as a processor, e.g., corresponding to processing circuitry 4170) coupled to the transceiver circuitry, and memory circuitry 405 (also referred to as memory, e.g., corresponding to device readable medium 4180 of FIG. 28) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the RAN node may be performed by processing circuitry 403, network interface 407, and/or transceiver 401. For example, processing circuitry 403 may control transceiver 401 to transmit downlink communications through transceiver 401 over a radio interface to one or more mobile terminals UEs and/or to receive uplink communications through transceiver 401 from one or more mobile terminals UEs over a radio interface. Similarly, processing circuitry 403 may control network interface 407 to transmit communications through network interface 407 to one or more other network nodes and/or to receive communications through network interface from one or more other network nodes. Moreover, modules may be stored in memory 405, and these modules may provide instructions so that when instructions of a module are executed by processing circuitry 403, processing circuitry 403 performs respective operations (e.g., operations discussed below with respect to Example Embodiments relating to RAN nodes).

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

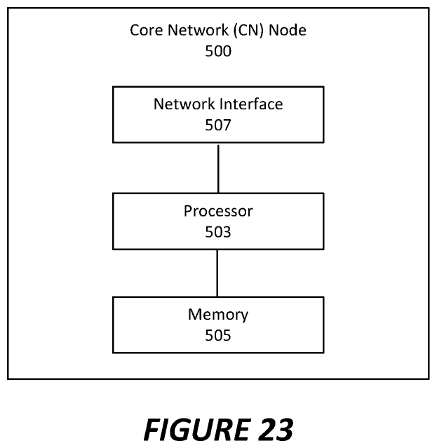

FIG. 23 is a block diagram illustrating elements of a core network CN node (e.g., an SMF node, an AMF node, etc.) of a communication network configured to provide cellular communication according to embodiments of inventive concepts. As shown, the CN node may include network interface circuitry 507 (also referred to as a network interface) configured to provide communications with other nodes of the core network and/or the radio access network RAN. The CN node may also include a processing circuitry 503 (also referred to as a processor) coupled to the network interface circuitry, and memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the CN node may be performed by processing circuitry 503 and/or network interface circuitry 507. For example, processing circuitry 503 may control network interface circuitry 507 to transmit communications through network interface circuitry 507 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to core network nodes).

It is yet to be seen which behavior will be specified for SCG power saving in rel-17. However, it is very likely that is going to be one or more of the following:
The UE starting to operate the PS Cell in dormancy, e.g. switching the PSCell to a dormant BWP). On the network side, the network considers the PSCell in dormancy and at least stops transmitting PDCCH for that UE in the PSCell(s);
The UE deactivating the PSCell like SCell deactivation; On the network side, the network considers the PSCell as deactivated and at least stops transmitting PDCCH for that UE in the PSCell;
The UE operating the PSCell in long DRX; SCG DRX can be switched off from the MN (e.g. via MCG MAC CE or DCI) when the need arises (e.g. DL data arrival for SN terminated SCG bearers);
The UE suspending its operation with the SCG (e.g. suspending bearers associated with the SCG, like SCG MN-/SN-terminated bearers), but keeping the SCG configuration stored (referred to as Stored SCG); On the network side there can be different alternatives such as the SN storing the SCG as the UE does, or the SN releasing the SCG context of the UE to be generated again upon resume (e.g. with the support from the MN that is the node storing the SCG context for that UE whose SCG is suspended).

Though the power saving aspect is so far discussed from the SCG point of view, it is likely that similar approaches could be used on the MCG as well (e.g. the MCG maybe suspended or in long DRX, while data communication is happening only via the SCG).

Mobility in connected state is also known as handover. The purpose of handover is to move the UE from a source node using a source radio connection (also known as source cell connection), to a target node, using a target radio connection (also known as target cell connection). The target radio connection is associated with a target cell controlled by the target access node. So, in other words, during a handover, the UE moves from the source cell to a target cell. Sometimes the source access node or the source cell is referred to as the “source”, and the target access node or the target cell is sometimes referred to as the “target”. The source access node and the target access node may also be referred to as the source node and the target node, the source radio network node and the target radio network node or the source gNB and the target gNB.

In some cases, the source access node and target access node are different nodes, such as different gNBs. These cases are also referred to as inter-node or inter-gNB handover. In other cases, the source access node and target access node are the same node, such as the same gNB. These cases are also referred to as intra-node or intra-gNB handover and covers the case when the source and target cells are controlled by the same access node. In yet other cases, handover is performed within the same cell, e.g. for the purpose of refreshing the security keys, and thus also within the same access node controlling that cell. These cases are referred to as intra-cell handover.

It should therefore be understood that the source access node and target access node refer to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An inter-node handover can further be classified as an Xn-based or NG-based handover depending on whether the source and target node communicate directly using the Xn interface or indirectly via the core network using the NG interface. In the remainder of this document we will only consider Xn based handover although some of the handover solutions described in the following sections may also be applied to NG-based handover.

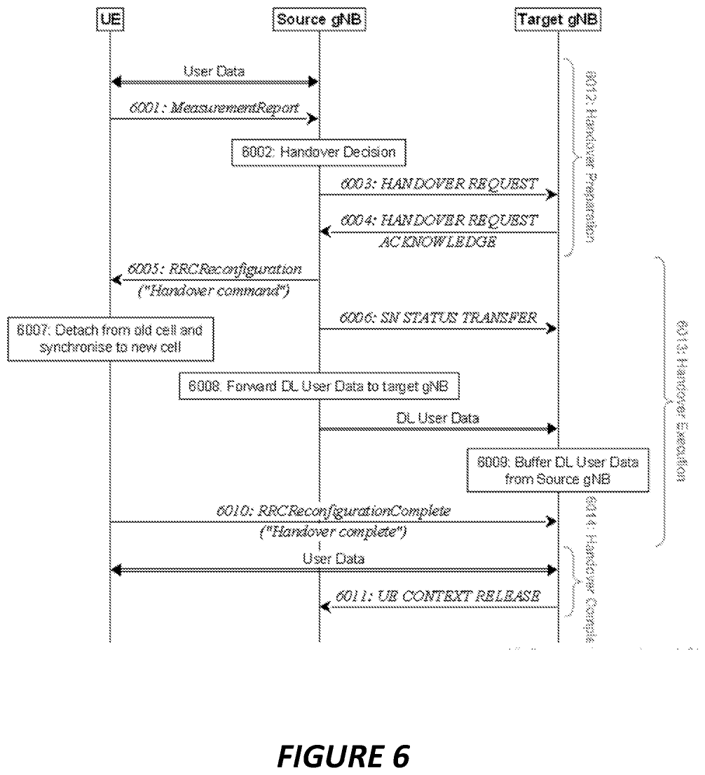

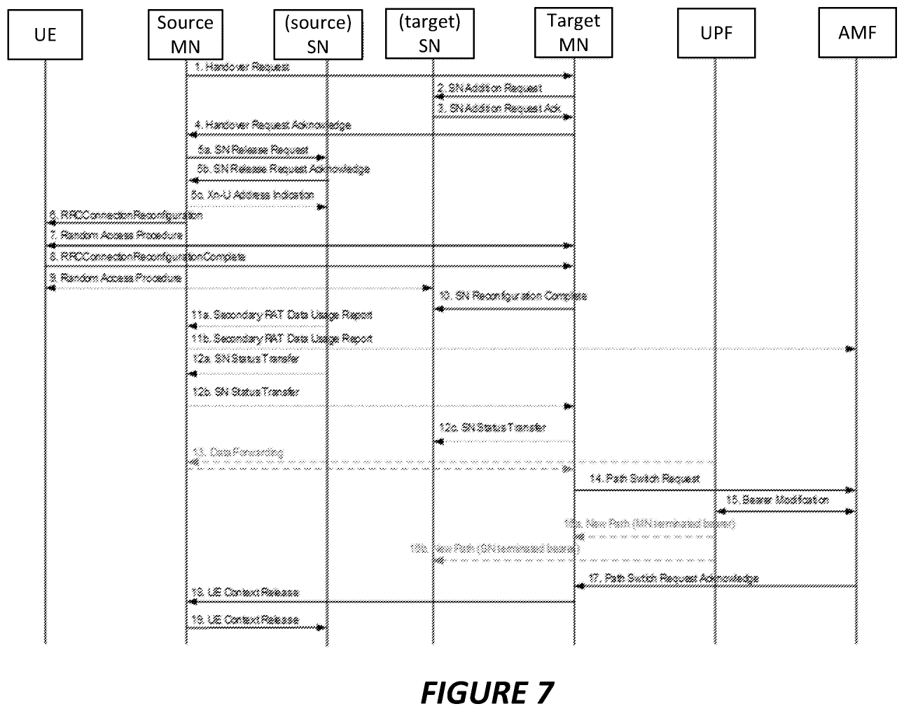

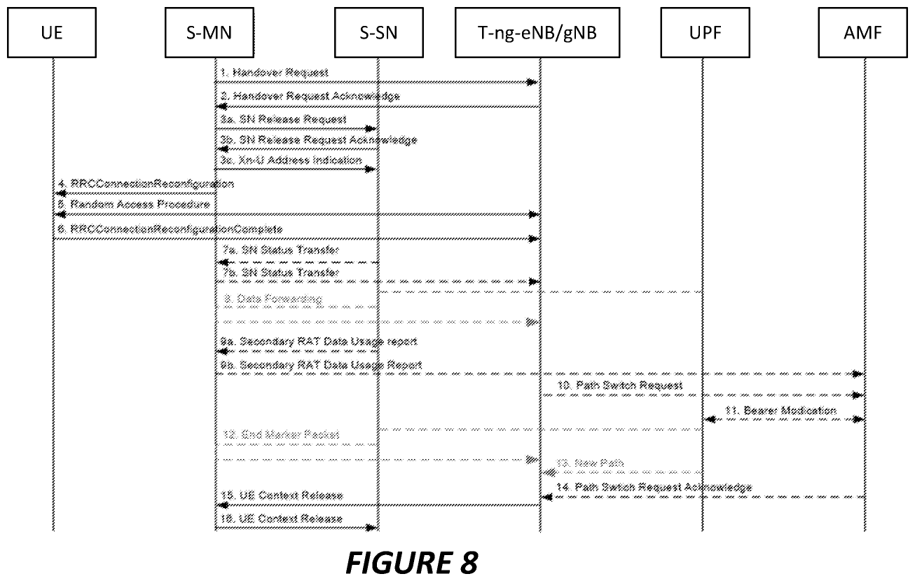

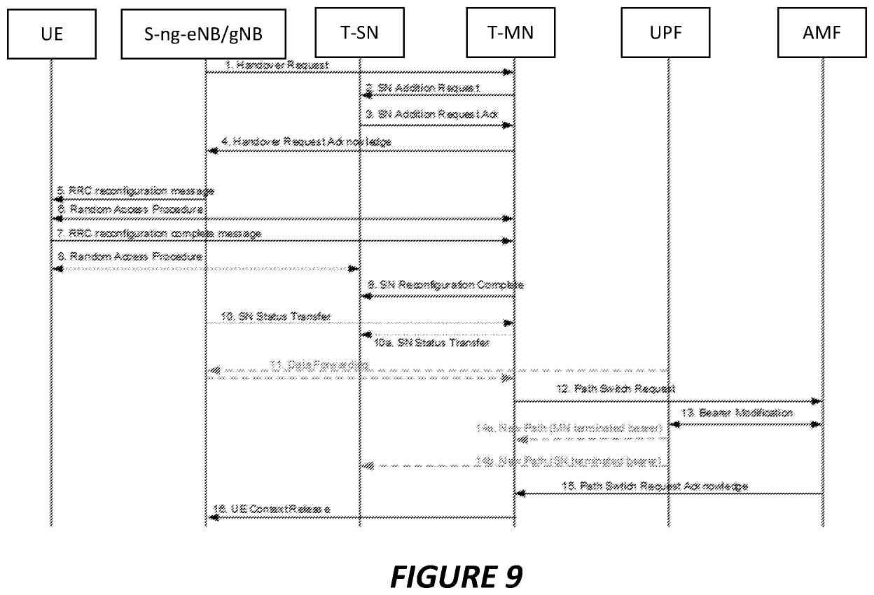

FIG. 6 shows the signaling flow between the UE and source and target access node during an inter-node handover in NR. In Steps 6001-6002, the UE and source gNB have an established connection and is exchanging user data. Due to some trigger, e.g. a measurement report from the UE, the source gNB decides to handover the UE to the target gNB. In step 6003, the source gNB sends a HANDOVER REQUEST message to the target gNB with necessary information to prepare the handover at the target side. The information includes among other things the current source configuration and the UE capabilities. In step 6004, The target gNB prepares the handover and responds with a HANDOVER REQUEST ACKNOWLEDGE message to the source gNB, which includes the handover command (an RRCReconfiguration message) to be sent to the UE. The handover command includes information needed by the UE to access the target cell, e.g., random access configuration, a new C-RNTI assigned by the target gNB and security parameters enabling the UE to calculate the target security key so the UE can send the handover complete message (an RRCReconfigurationComplete message). If the target gNB does not support the release of the RRC protocol which the source gNB used to configure the UE, the target gNB may be unable to comprehend the UE configuration provided by the source eNB in the HANDOVER REQUEST. In this case, the target gNB can use so called “full configuration” option in the handover command to reconfigure the UE for handover. The full configuration option includes an initialization of the radio configuration, which makes the procedure independent of the configuration used in the source cell. Otherwise the target node uses so called “delta configuration” where only the difference from the UE's configuration in the source cell is included in the handover command. Delta configuration typically reduces the size of the handover command which increases the speed and robustness of the handover.

In Step 6005 of FIG. 6, The source gNB triggers the handovers by sending the handover command (a RRCReconfiguration message) received from the target node in the previous step to the UE. The UE detaches from the old cell before synchronizing and connecting to the new cell. Step 6006 of FIG. 6 illustrates that the source gNB stops scheduling any further DL or UL data to the UE and sends a SN STATUS TRANSFER message to the target gNB indicating the latest PDCP SN transmitter and receiver status. In Steps 6007-6008, The source node now also starts to forward User Data to the target node, which buffers this data for now. FIG. 6 also illustrates, in step 6010, that once the UE the has completed the random access to the target cell, the UE sends the handover complete (an RRCReconfigurationComplete message) to the target gNB. In Step 6011, upon receiving the handover complete message, the target node can start exchanging user data with the UE. The target node also requests the AMF to switch the DL data path from the UPF from the source node to the target node (not shown). Once the path switch is completed the target node sends the UE CONTEXT RELEASE message to the source node.

The following procedures described in TS 37.340 are related to MCG mobility (inter-MN/intra-MN):
Inter-Master Node handover with/without Secondary Node change; Master Node to eNB/gNB Change;
eNB/gNB to Master Node change;

Each of these could be described for MR-DC with the EPC (EN-DC) and MR-DC with the 5GC, but for the sake of brevity only the MR-DC with the 5GC cases are shown herein. Further details may be found in TS 37.340.

Inter-MN handover with/without MN initiated SN change, illustrated in Error! Reference source not found., is used to transfer UE context data from a source MN to a target MN while the UE context at the SN is kept or moved to another SN. During an Inter-Master Node handover, the target MN decides whether to keep or change the SN (or release the SN, as described in clause 10.8 of TS 37.340). Only intra-RAT Inter-Master node handover with/without SN change is supported (e.g. no transition from NGEN-DC to NR-DC). In this case the UE is in MR-DC and receives a command for MCG mobility, and after that, it remains in MR-DC.

The MN to ng-eNB/gNB Change procedure, illustrated in Error! Reference source not found., is used to transfer UE context data from a source MN/SN to a target ng-eNB/gNB. Both the cases where the source MN and the target node belong to the same RAT (i.e. they are both ng-eNBs or both gNBs) and the cases where the source MN and the target node belong to different RATs are supported. In this case the UE is in MR-DC and receives a command for MCG mobility, and after that, it leaves MR-DC (i.e. it releases the SCG upon the MCG reconfiguration with sync).

The ng-eNB/gNB to MN change procedure, illustrated in Error! Reference source not found., is used to transfer UE context data from a source ng-eNB/gNB to a target MN that adds an SN during the handover. Only the cases where the source node and the target MN belong to the same RAT (i.e. they are both ng-eNBs or both gNBs) are supported.

The following procedures described in TS 37.340 are related to SCG mobility (inter-SN/inter-SN):
Secondary Node Modification (MN/SN initiated);
Secondary Node Release (MN/SN initiated);
Secondary Node Change (MN/SN initiated);

Each of these could be described for MR-DC with the EPC (EN-DC) and MR-DC with the 5GC, but for the sake of brevity only the MR-DC with the 5GC cases are shown herein. Further details may be found in TS 37.340.

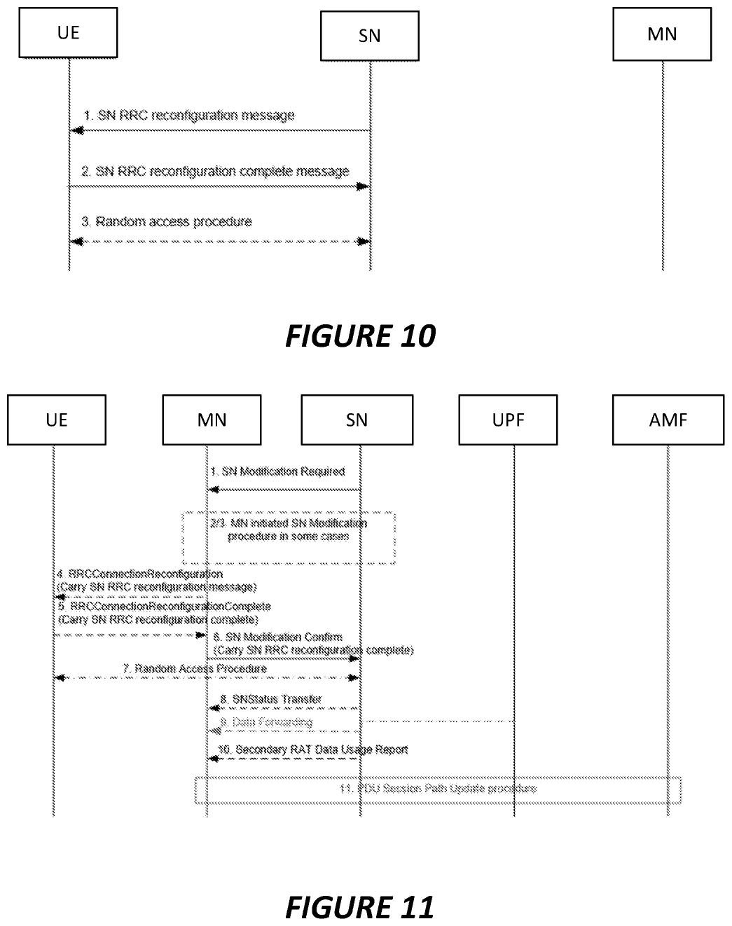

The SN Modification procedure may be initiated either by the MN or by the SN and be used to modify the current user plane resource configuration (e.g. related to PDU session, QoS flow or DRB) or to modify other properties of the UE context within the same SN. FIG. 10 illustrates SN Modification without MN involvement. This procedure is not supported by NE-DC. The SN initiated SN modification procedure without MN involvement is used to modify the configuration within SN in case no coordination with MN is required, including the addition/modification/release of SCG SCell and PSCell change (e.g. when the security key does not need to be changed and the MN does not need to be involved in PDCP recovery). The SN may initiate the procedure to configure or modify CPC configuration within the same SN. Figure shows an example signaling flow for SN initiated SN modification procedure without MN involvement. The SN can decide whether the Random Access procedure is required.

FIG. 11 illustrates SN initiated SN modification with MN involvement. The SN uses the procedure to perform configuration changes of the SCG within the same SN, e.g. to trigger the modification/release of the user plane resource configuration and to trigger PSCell changes (e.g. when a new security key is required or when the MN needs to perform PDCP data recovery). The MN cannot reject the release request of PDU session/QoS flows. The SN also uses the procedure to request the MN to provide more DRB IDs to be used for SN terminated bearers or to return DRB IDs used for SN terminated bearers that are not needed any longer. FIG. 11 shows an example signaling flow for SN initiated SN Modification procedure.

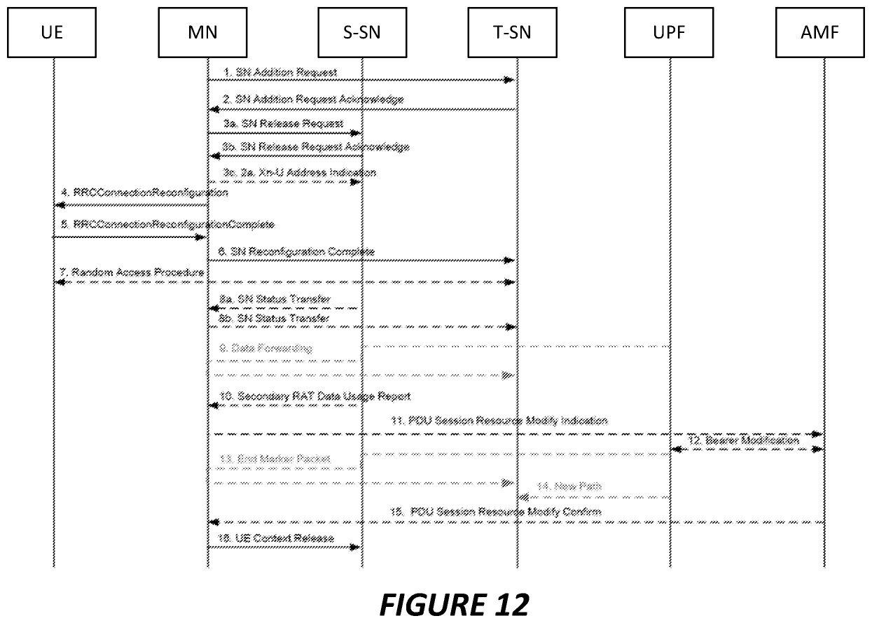

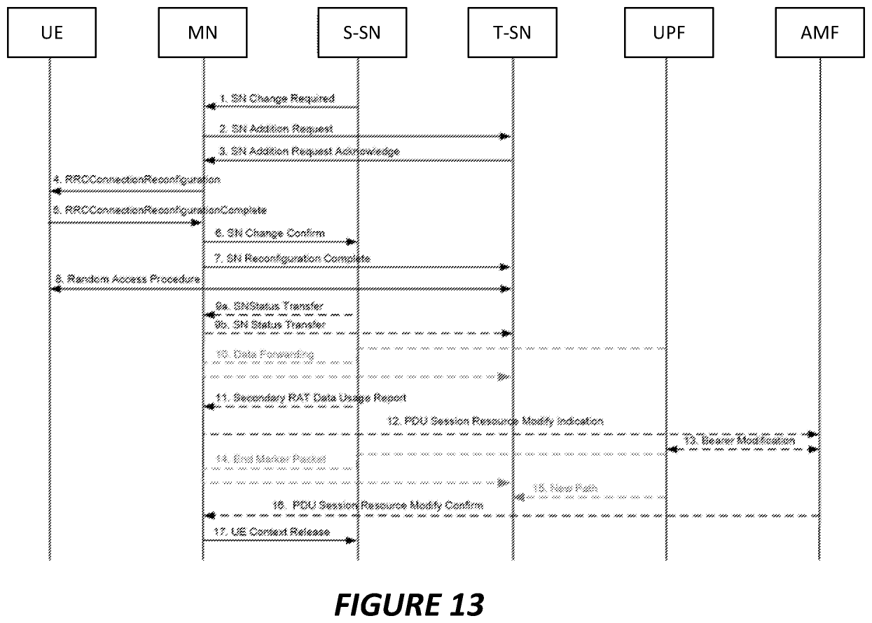

FIG. 12 illustrates MN initiated SN change procedure. The MN initiated SN change procedure illustrated in FIG. 12 is used to transfer a UE context from the source SN to a target SN and to change the SCG configuration in UE from one SN to another. The Secondary Node Change procedure always involves signaling over MCG SRB towards the UE. FIG. 13 illustrates SN initiated SN change procedure. The SN initiated SN change procedure illustrated in FIG. 13 is used to transfer a UE context from the source SN to a target SN and to change the SCG configuration in UE from one SN to another.

In dual connectivity, the UE can perform UL/DL transmissions/receptions towards a Master Node (MN) and/or Secondary Node (SN) (for data transmission/reception using the associated MCG and/or SCG radio links). In typical scenarios, the MCG can be considered to offer basic coverage and the SCG used to increase the data rate during data bursts. The UE needs to continuously monitor the PDCCH for uplink and downlink scheduling assignments at least on the PCell and the PSCell, and potentially all other SCells if cross carrier scheduling is not employed. Even if cross carrier scheduling is employed, the UE has to perform extra PDCCH monitoring on the PCell or the PSCell for the sake of the SCell, depending on whether the SCell belongs to the MCG or the SCG.

It has been proposed to introduce a SCG power saving state, here referred to as “SCG deactivated state” which can be configured in the UE. For example, it has been suggested that a UE with an SCG configured in SCG deactivated state, in order to save power in this state, does not need to monitor the Physical Downlink Control Channel (PDCCH) on the PSCell. And for example, it has been suggested that a UE with an SCG configured in SCG deactivated state only perform a subset of the RRM measurements it would perform when the SCG is configured in SCG activated state, Also, it has been proposed procedures to enable “fast activation and deactivation” of the SCG, in other words, procedures to efficiently perform transitions between the “SCG activated state” and the SCG deactivated state.

Problem 1: While the UE's configured with an SCG in deactivated state, the UE may move away from the coverage of the PCell (e.g. PCell RSRP starts to drop) and/or the UE may enter the coverage of cells in the same frequency of the PCell that may be in better radio conditions (e.g. a neighbor cell in the same frequency of the PCell has better RSRQ than the PCell, while the SCG is in a power saving mode of operation). As that may create interference in the PCell frequency, the network may want to trigger a PCell change (or an MCG change), possibly towards a target PCell in another node (MCG change with MN change).

While there exists procedures currently defined for an MCG mobility with or without an MN change, wherein the SN can be kept, released or changed, these procedures do not take into account the possibility that the SCG may be in deactivated state. With the support for SCG deactivated state, information about the state of the SCG (i.e. whether it is in deactivated state or in activated state) will then be needed in the UE, the SN and the (source and target) MN.

Problem 2: Similarly, while the UE's configured with an SCG in deactivated state, the UE may move away from the coverage of that PSCell (e.g. PSCell RSRP starts to drop) and/or the UE may enter the coverage of cells in the same frequency of the PSCell that may be in better radio conditions (e.g. a neighbor cell in the same frequency of the PSCell of the SCG that is deactivated has better RSRQ than the suspended PSCell). While that may not necessarily create interference in the PSCell frequency, in case in deactivated SCG transmissions and receptions would be suspended, when the network wants to activate the SCG (or in general, transition the SCG to a normal mode of operation), that PSCell of the deactivated SCG is either not in good coverage or is not the best in terms of radio conditions (e.g. SINR and/or RSRQ) compared to some other neighbor cell, so that, resuming such a PSCell could lead to a resume that fails (e.g. due to the interference of that neighbor with stronger radio conditions) or, even if activation succeeds, that could be immediately followed up by a reconfiguration with sync e.g. a PSCell change.

While there exist procedures to perform SCG mobility, with or without SN change, these procedures do not take into account the possibility that the SCG may be in deactivated state. With the support for SCG deactivated state, information about the state of the SCG (i.e. whether it is in deactivated state or in activated state) will then be needed in the UE, the MN and the (source and target) SN.

The present disclosure describes mechanisms to allow master cell group (MCG) mobility and secondary cell group (SCG) mobility while the SCG is in a power saving state, also known as deactivated state or suspended state. More specifically, the present disclosure describes methods for the UE to determine the SCG state for power saving (as either SCG activated state or SCG deactivated state) as result of the MCG or SCG mobility procedure. In one embodiment, during an MCG or SCG mobility procedure, the UE determines the SCG to be in activated state, as result of the MCG or SCG mobility procedure, independent of the SCG state for power saving before the mobility procedure was initiated.

The present disclosure also describes methods for a network node, such as a master node (MN) or a secondary node (SN), to determine the SCG state for power saving (as either SCG activated state or SCG deactivated state) as a result of the MCG or SCG mobility procedure. In one embodiment, the network node always determines the SCG to be in activated state, independent of the SCG state for power saving before the mobility procedure was initiated. In another embodiment, the network node determines the SCG state for power saving based on reception of a message from the UE during the mobility procedure. In some embodiments when UE always assumes that the SCG is activated as result of the mobility procedure, the solution makes it possible to perform MCG or SCG mobility where the target node (target MN or target SN, respectively) does not support an SCG power saving mode, also known as SCG deactivated state or SCG suspended state.

According to embodiments of the present disclosure, a UE operates in dual connectivity with a master cell group (MCG) controlled by the master node (MN) and a secondary cell group (SCG) controlled by a secondary node (SN). In one embodiment the mobility procedure concerns MCG mobility from the current MCG, known as the source MCG, controlled by a source network node, known as the source master node (MN), to a target MCG controlled by a target network node, known as the target master node (MN). In another embodiment the mobility procedure concerns SCG mobility from the current SCG, known as the source SCG controlled by a source network node, the known as the source secondary node (SN), to a target SCG controlled by a target network node, known as the target secondary node (SN).

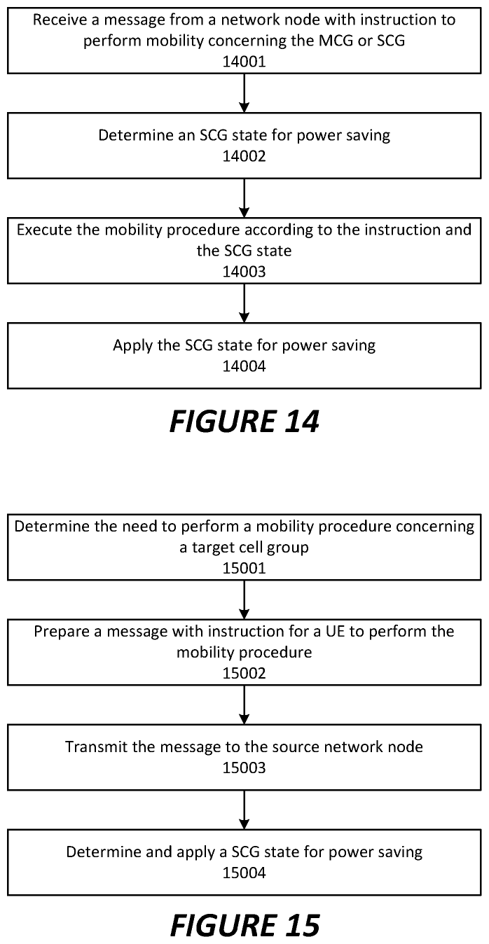

FIG. 14 illustrates steps of a method performed by the UE according to some embodiments. In Step 14001 of FIG. 14, the UE receives a message, such as an RRC message, from a network node with instruction to perform mobility concerning the MCG or SCG. In one example, the message is an RRCReconfiguration message including the field reconfigurationWithSync for an SpCell in either the masterCellGroup or secondaryCellGroup part of the message

In Step 14002 of FIG. 14, the UE determines an SCG state for power saving and applies the determined SCG state in the configuration. In Step 14003 of FIG. 14, the UE executes the mobility procedure according to the instruction and the determined SCG state, for example performing the Reconfiguration with sync procedure specified in TS 38.331 with the target cell corresponding to the included SpCell in either masterCellGroup or secondaryCellGroup part of the received message. In Step 14004, the UE applies the SCG state for power saving.

In one embodiment, the determined SCG state for power saving is always SCG activated state (independent of the previous SCG state for power saving) as a result of the execution of an MCG mobility procedure or an SCG mobility procedure. In another embodiment, the UE assumes the SCG state for power saving as result of the mobility procedure to remain the same as before the mobility procedure was activated. When applying the determined SCG state, the UE performs the required procedures for the SCG according to the applied state. For example, if the determined SCG state is SCG deactivated, for example when the source SCG was in deactivated state, the UE does not perform PDCCH monitoring on the PSCell within the SCG. And in one example, if the determined SCG state is SCG deactivated, the UE performs certain RRM measurements on cells according to the requirements for SCG deactivated state. And in another example, if the UE determined SCG state is SCG activated, the UE performs random access on the PSCell of the SCG.

FIG. 15 illustrates the steps of a method performed by a target network node according to some embodiments of a mobility procedure. FIG. 15 illustrates the target network node determines the need to perform a mobility procedure to a target cell group (such as an MCG or SCG) controlled by the target network node in step 15001. In one example, the target network node determines the need to perform a mobility procedure when the source network node initiates a mobility preparation procedure. In another example, the target network node determines the need to perform a mobility procedure when a third node, such as a master node, triggers the mobility preparation procedure.

In Step 15002 of FIG. 15, the target network node performs preparation of a message, such as an RRC message, with instruction for a UE to perform the mobility procedure to a target cell group controlled by the target node. In one example, the message instructs the UE to perform MCG mobility and the RRCReconfiguration message includes the field reconfigurationWithSync for an SpCell in the masterCellGroup part of the message. In another example, the message instructs the UE to perform SCG mobility and the RRCReconfiguration message includes the field reconfigurationWithSync for an SpCell in the secondaryCellGroup part of the message. FIG. 15 illustrates, in Step 15003, the target network node transmits the message to the source network node as part of the mobility preparation procedure.

FIG. 15 also illustrates the target network node determines an SCG state for power saving and applies the determined SCG state as shown in step 15004. In one embodiment, the determined SCG state for power saving is always SCG activated state (independent of the previous SCG state for power saving) as a result of the execution of an MCG mobility procedure or an SCG mobility procedure. An advantage of this embodiment is that the target network node does not need to support the SCG deactivated state. In another embodiment, the determined the SCG state for power saving is based on reception of a message from the UE during the mobility procedure. For example, if the target network node receives a message from the UE, such as an RRCReconfigurationComplete message, or if the UE performs a random access procedure in the target cell group, the target network node determines that the SCG state for power saving is SCG activated state. In another example, the received message from the UE, such as an RRCReconfigurationComplete message includes an indication of the SCG state for power saving as field or an information element.

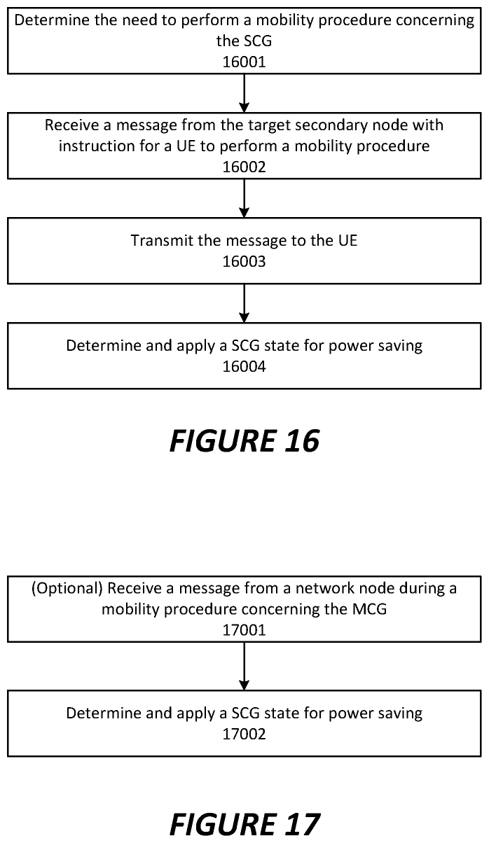

FIG. 16 illustrates steps of a method performed by a master node (MN) in one embodiment of a mobility procedure. In this embodiment the mobility procedure concerns SCG mobility from the current SCG, known as the source SCG controlled by the secondary node (SN), known as the source SN to a target SCG controlled by a target secondary node (SN). The master node controls the MCG used by the UE during the mobility procedure. In step 16001, the master node determines the need to perform a mobility procedure concerning the SCG to a target cell group controlled by a target network node. The determination may for example be based on received measurement reports from the UE. In another example the source network node determines the need to perform a mobility procedure when a when a third node, such as a master node, triggers the mobility preparation procedure. As part of the mobility preparation procedure, the source network node in one example requests the target network node to prepare a message to be sent to the UE, such as an RRC message.

In Step 16002 of FIG. 16, As part of the mobility preparation procedure, in one embodiment the master node receives a message, such as an RRC message, from the target node with instruction for a UE to perform a mobility procedure to a target cell group controlled by the target network node. In another embodiment, the source network node prepares the message. In Step 16003 of FIG. 16, the master node transmits the message to the UE. In another example, the message instructs the UE to perform SCG mobility and the RRCReconfiguration message includes the field reconfigurationWithSync for an SpCell in the secondaryCellGroup part of the message. Step 16004 of FIG. 16 illustrates the master node determines the SCG state for power saving and applies the determined SCG state. In one embodiment, the determined SCG state for power saving is always SCG activated state (independent of the previous SCG state for power saving) as a result of the execution the SCG mobility procedure. An advantage of this embodiment is that the target network node or the master node do not need to support the SCG deactivated state. In another embodiment, the determined the SCG state for power saving is based on reception of a message from the UE or an indication from another network node, such as the target network node, during the mobility procedure, that was initiated by the master node or a secondary node. In yet another embodiment, the determined the SCG state for power saving as result of the mobility procedure is the same state as before the mobility procedure.

FIG. 17 illustrates the steps of a method performed by a secondary node (SN) in one embodiment of a mobility procedure. In this embodiment the mobility procedure concerns MCG mobility from the current MCG, known as the source MCG, controlled by the master node (MN), known as the source MN to a target MCG controlled by a target master node (MN). The secondary node controls the SCG used by the UE during the mobility procedure. FIG. 17 illustrates an optional step 17001 in which, during a mobility procedure concerning an MCG, the secondary node may receive a message from a network node, such as the source MN or target MN. In one example, this message includes an indication of the SCG state for power saving.

In Step 17002 of FIG. 17, the secondary node determines the SCG state for power saving and applies the determined SCG state. In one example the determined SCG state for power saving is always SCG activated state. The advantage in this example is that the target MN does not need to support SCG deactivated state. In another example, determined SCG state for power saving is based on the indication in the received message from the network node in the previous step. In another example, if the UE performs random access in the PSCell of the SCG, the secondary node determines the SCG state for power saving as SCG activated state.

An example implementation to be included in 3GPP TS 38.331 (v16.2.0) can be seen in Table 1 below, where additions are marked as underlined text.

TABLE 1
Example Changes to 3GPP TS 38.331

5.3.5.3 Reception of an RRCReconfiguration by the UE
The UE shall perform the following actions upon reception of the
RRCReconfiguration, or upon execution of the conditional reconfiguration (CHO or
CPC):
< Skipped some parts >

| 1> | if reconfigurationWithSync was included in spCellConfig of an MCG or SCG, and | |
|---|---|---|
| | when MAC of an NR cell group successfully completes a Random Access | |
| | procedure triggered above: | |
| | 2> | stop timer T304 for that cell group; |
| | 2> | stop timer T310 for source SpCell if running; |
| | 2> | apply the parts of the CSI reporting configuration, the scheduling request |
| | | configuration and the sounding RS configuration that do not require the UE to |
| | | know the SFN of the respective target SpCell, if any; |
| | 2> | apply the parts of the measurement and the radio resource configuration that |
| | | require the UE to know the SFN of the respective target SpCell (e.g. |
| | | measurement gaps, periodic CQI reporting, scheduling request configuration, |
| | | sounding RS configuration), if any, upon acquiring the SFN of that target SpCell; |
| | 2> | for each DRB configured as DAPS bearer, request uplink data switching to the |
| | | PDCP entity, as specified in TS 38.323 [5]; |
| | 2> | set the SCG state for power saving to SCG activated; |
| | 2> | if the reconfigurationWithSync was included in spCellConfig of an MCG: |

| | |
|---|---|
| 3> | if T390 is running: |

| | |
|---|---|
| 4> | stop timer T390 for all access categories; |
| 4> | perform the actions as specified in 5.3.14.4. |

| | |
|---|---|
| 3> | if T350 is running: |

| | |
|---|---|
| 4> | stop timer T350; |

| | |
|---|---|
| 3> | if RRCReconfiguration does not include dedicatedSIB1-Delivery and |
| 3> | if the active downlink BWP, which is indicated by the |

| firstActiveDownlinkBWP-Id for the target SpCell of the MCG, has a common | |
|---|---|
| search space configured by searchSpaceSIB1: | |
| 4> | acquire the SIB1, which is scheduled as specified in TS 38.213 [13], of the |
| | target SpCell of the MCG; |
| 4> | upon acquiring SIB1, perform the actions specified in clause 5.2.2.4.2; |

| | |
|---|---|
| 2> | if the reconfigurationWithSync was included in spCellConfig of an MCG; or: |
| 2> | if the reconfigurationWithSync was included in spCellConfig of an SCG and the |

| CPC was configured | |
|---|---|
| 3> | remove all the entries within VarConditionalReconfig, if any; |
| 3> | for each measId of the source SpCell configuration, if the associated |

| reportConfig has a reportType set to condTriggerConfig: | |
|---|---|
| 4> | for the associated reportConfigId: |

| | |
|---|---|
| 5> | remove the entry with the matching reportConfigId from the |

reportConfigList within the VarMeasConfig;

| | |
|---|---|
| 4> | if the associated measObjectId is only associated to a reportConfig with |

| reportType set to condTriggerConfig: | |
|---|---|
| 5> | remove the entry with the matching measObjectId from the |

measObjectList within the VarMeasConfig;

| | |
|---|---|
| 4> | remove the entry with the matching measId from the measIdList within the |

VarMeasConfig;

| 2> | if reconfigurationWithSync was included in masterCellGroup or |
|---|---|
| | secondaryCellGroup; and |
| 2> | if the UE transmitted a UEAssistanceInformation message for the corresponding |

| cell group during the last 1 second, and the UE is still configured to provide the | |
|---|---|
| concerned UE assistance information for the corresponding cell group: | |
| 3> | initiate transmission of a UEAssistanceInformation message for the |
| | corresponding cell group in accordance with clause 5.7.4.3 to provide the |
| | concerned UE assistance information; |
| 3> | start or restart the prohibit timer (if exists) associated with the concerned UE |

assistance information with the timer value set to the value in corresponding
configuration;

| | |
|---|---|
| 2> | if SIB12 is provided by the target PCell; and the UE transmitted a |

| SidelinkUEInformationNR message indicating a change of NR sidelink | |
|---|---|
| communication related parameters relevant in target PCell (i.e. change of sl- | |
| RxInterestedFreqList or sl-TxResourceReqList) during the last 1 second | |
| preceding reception of the RRCReconfiguration message including | |
| reconfigurationWithSync in spCellConfig of an MCG: | |
| 3> | initiate transmission of the SidelinkUEInformationNR message in accordance |

with 5.8.3.3;

| | |
|---|---|
| 2> | the procedure ends. |

| | |
|---|---|
| NOTE 3: | The UE is only required to acquire broadcasted SIB1 if the UE can acquire it |
| | without disrupting unicast data reception, i.e. the broadcast and unicast beams |
| | are quasi co-located. |
| NOTE 4: | The UE sets the content of UEAssistanceInformation according to latest |
| | configuration (i.e. the configuration after applying the RRCReconfiguration |
| | message) and latest UE preference. The UE may include more than the |
| | concerned UE assistance information within the UEAssistanceInformation |
| | according to 5.7.4.2. Therefore, the content of UEAssistanceInformation |
| | message may not be similar to the original one. |

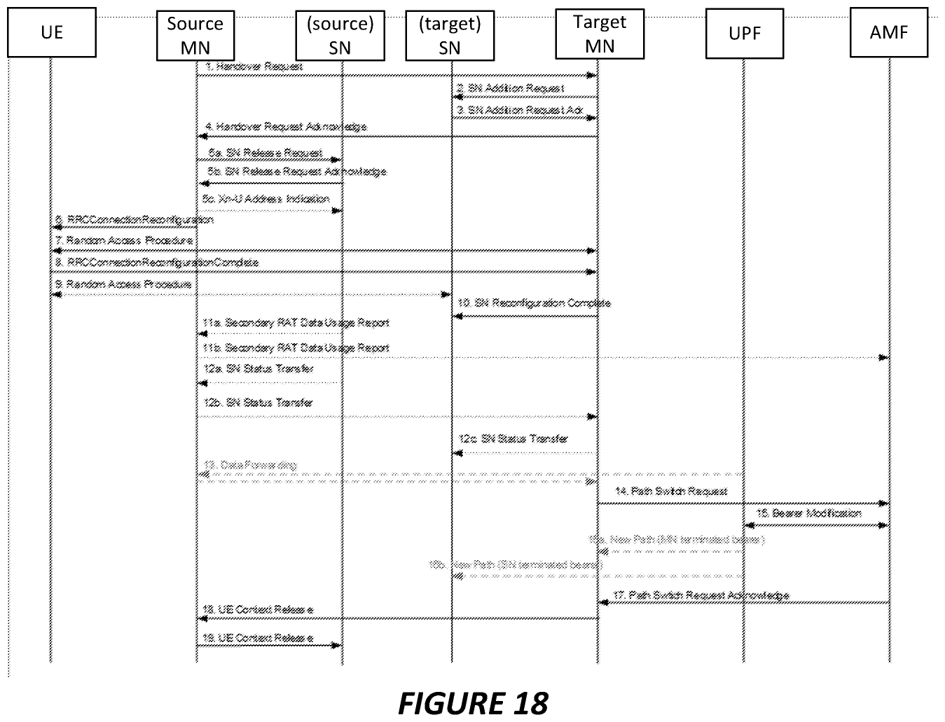

An example implementation of the embodiment that the SCG state for power saving is always set to SCG activated state, for the case of MN mobility while SCG is deactivated can be seen in Table 2 below, based on 3GPP TS 37.340 (v16.3.0), clause 10.7.2, where additions are marked as underlined text. FIG. 18 illustrates an example signaling flow for inter-MN handover with or without MN initiated SN change according to some embodiments. Descriptions of each of the steps in the signaling flow diagram are also described below.

TABLE 2
Example Changes to 3GPP TS 37.340, clause 10.7.2

| | |
|---|---|
| NOTE 1: | For an Inter-Master Node handover without Secondary Node change, the source |
| | SN and the target SN shown in FIG. 18 are the same node. |
| 1. | The source MN starts the handover procedure by initiating the Xn Handover Preparation |
| | procedure including both MCG and SCG configuration. The source MN includes the |
| | source SN UE XnAP ID, SN ID and the UE context in the source SN in the |
| | Handover Request message. |
| NOTE 2: | The source MN may trigger the MN-initiated SN Modification procedure (to |
| | the source SN) to retrieve the current SCG configuration and to allow provision of |
| | data forwarding related information before step 1. |
| 2. | If the target MN decides to keep the source SN, the target MN sends SN Addition |
| | Request to the SN including the SN UE XnAP ID as a reference to the UE context in the |
| | SN that was established by the source MN. If the target MN decides to change the SN, |
| | the target MN sends the SN Addition Request to the target SN including the UE context |
| | in the source SN that was established by the source MN. |
| 3. | The (target) SN replies with SN Addition Request Acknowledge. The (target) SN may |
| | include the indication of the full or delta RRC configuration. |
| 4. | The target MN includes within the Handover Request Acknowledge message the MN |
| | RRC reconfiguration message to be sent to the UE in order to perform the handover, and |
| | may also provide forwarding addresses to the source MN. If PDU session split is |
| | performed in the target side during handover procedure, more than one data forwarding |
| | addresses corresponding to each node are included in the |
| | Handover Request Acknowledge message. The target MN indicates |
| | to the source MN that the UE context in the SN is kept if the target MN and |
| | the SN decided to keep the UE context in the SN in step 2 and step 3. |
| 5a/5b. | The source MN sends SN Release Request message to the (source) SN |
| | including a Cause indicating MCG mobility. The (source) SN acknowledges the release |
| | request. The source MN indicates to the (source) SN that the UE context in SN is kept, if |
| | it receives the indication from the target MN. If the indication as the UE context kept in |
| | SN is included, the SN keeps the UE context. |
| 5c. | The source MN sends XN-U Address Indication message to the (source) SN to transfer |
| | data forwarding information. More than one data forwarding addresses may be provided |
| | if the PDU session is split in the target side. |
| 6. | The source MN triggers the UE to perform handover and apply the new configuration. |
| | The UE determines that the SCG state for power saving is changed to SCG activated |
| | state as part of the handover (in case it was SCG deactivated state prior to reception of |
| | the RRC Reconfiguration message). |
| 7/8. | The UE synchronizes to the target MN and replies with MN RRC reconfiguration |
| | complete message. |
| 9. | If configured with bearers requiring SCG radio resources, the UE synchronizes to the |
| | (target) SN. |
| 10. | If the RRC connection reconfiguration procedure was successful, the target MN |
| | informs the (target) SN via SN Reconfiguration Complete message. (Optionally) The |
| | reception of the SN Reconfiguration Complete message indicating MN mobility |
| | indicates that the SCG state for power saving is SCG activated state, in case it was SCG |
| | deactivated state prior to the handover. |
| 11a. | The source SN sends the Secondary RAT Data Usage Report message to the source |
| | MN and includes the data volumes delivered to and received from the UE over the |
| | NR/E-UTRA radio as described in clause 10.11.2. |
| NOTE 2a: | The order the source SN sends the Secondary RAT Data Usage Report message |
| | and performs data forwarding with MN/target SN is not defined. The SN may send |
| | the report when the transmission of the related QoS is stopped. |
| 11b. | The source MN sends the Secondary RAT Report message to AMF to provide |
| | information on the used NR/E-UTRA resource. |
| 12. | For bearers using RLC AM, the source MN sends the SN Status Transfer to the target |
| | MN, including, if needed, SN Status received from the source SN. The target forwards |
| | the SN Status to the target SN, if needed. |
| 13. | If applicable, data forwarding takes place from the source side. If the SN is kept, data |
| | forwarding may be omitted for SN terminated bearers or QoS flows kept in the SN. |
| 14-17. | The target MN initiates the Path Switch procedure. If the target MN includes |
| | multiple DL TEIDs for one PDU session in the Path Switch Request message, multiple |
| | UL TEID of the UPF for the PDU session should be included in the Path Switch Ack |
| | message in case there is TEID update in UPF. |
| NOTE 3: | If new UL TEIDs of the UPF for SN are included, the target MN performs MN |
| | initiated SN Modification procedure to provide them to the SN. |
| 18. | The target MN initiates the UE Context Release procedure towards the source MN. |
| 19. | Upon reception of the UE Context Release message from source MN, the (source) SN |
| | releases C-plane related resources associated to the UE context towards the source MN. |
| | Any ongoing data forwarding may continue. The SN shall not release the UE context |
| | associated with the target MN if the UE contest kept indication was included in the |
| | SN Release Request message in step 5. |

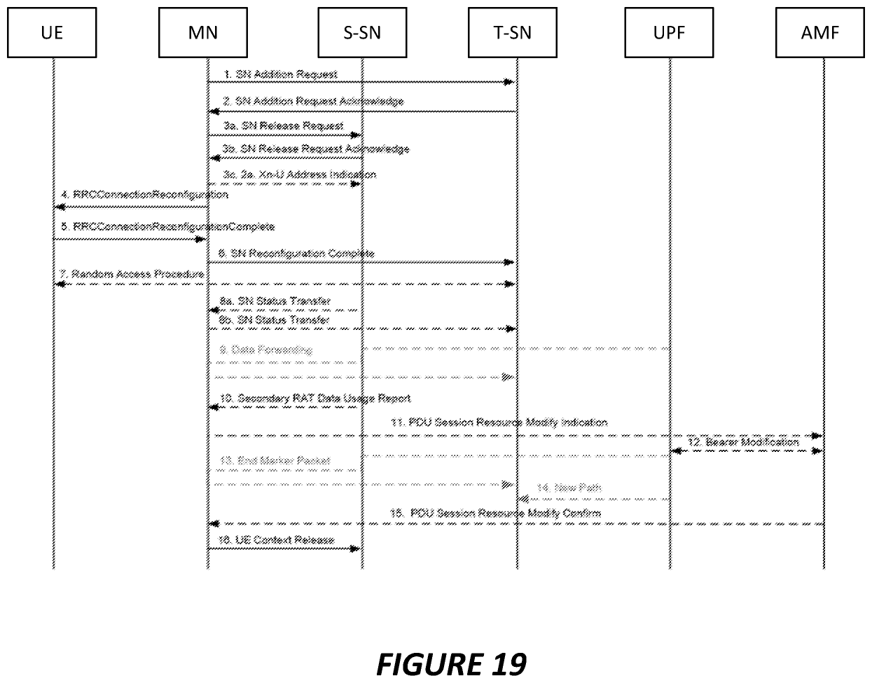

An example implementation of the embodiment that the SCG state for power saving is always set to SCG activated state, for the case of MN initiated SN mobility (when the SCG is deactivated) can be seen in Table 3 below, based on 3GPP TS 37.340 (v16.3.0), clause 10.5.2, where additions are marked as underlined text. FIG. 19 illustrates an example signaling flow for the SN change initiated by the MN according to some embodiments. Descriptions of each of the steps in the signaling flow diagram are also described below.

TABLE 3
Example Changes to 3GPP TS 37.340, clause 10.5.2

| | |
|---|---|
| 1/2. | The MN initiates the SN change by requesting the target SN to allocate resources for |
| | the UE by means of the SN Addition procedure. The MN may include measurement |
| | results related to the target SN. If data forwarding is needed, the target SN provides data |
| | forwarding addresses to the MN. The target SN includes the indication of the full or |
| | delta RRC configuration. (Optionally) In case the SCG state for power saving is SCG |
| | deactivated state (and the target SN supports SCG state for power saving), the target |
| | SN includes a change to SCG activated state in the SCG configuration of the RRC |
| | configuration that is to be sent to the UE. Optionally the MN indicates to the target SN |
| | that the SCG state for power saving shall be SCG activated state. |
| NOTE 1: | The MN may trigger the MN-initiated SN Modification procedure (to the |
| | source SN) to retrieve the current SCG configuration and to allow provision of |
| | data forwarding related information before step 1. |
| 3. | If the allocation of target SN resources was successful, the MN initiates the release of the |
| | source SN resources including a Cause indicating SCG mobility. The Source SN may |
| | reject the release. If data forwarding is needed the MN provides data forwarding |
| | addresses to the source SN. If direct data forwarding is used for SN terminated bearers, |
| | the MN provides data forwarding addresses as received from the target SN to source SN. |
| | Reception of the SN Release Request message triggers the source SN to stop providing |
| | user data to the UE. |
| 4/5. | The MN triggers the UE to apply the new configuration. The MN indicates the new |
| | configuration to the UE in the MN RRC reconfiguration message including the target SN |
| | RRC reconfiguration message. The UE applies the new configuration and sends the MN |
| | RRC reconfiguration complete message, including the SN RRC response message for |
| | the target SN, if needed. In case the UE is unable to comply with (part of) the |
| | configuration included in the MN RRC reconfiguration message, it performs the |
| | reconfiguration failure procedure. In case the SCG state for power saving was SCG |
| | deactivated state in the source SN the UE determines that the SCG state for power |
| | saving is changed to SCG activated state in the target SN. The MN determines that the |
| | SCG state for power saving is (changed to) SCG activated state. |
| 6. | If the RRC connection reconfiguration procedure was successful, the MN informs the |
| | target SN via SN Reconfiguration Complete message with the included SN RRC |
| | response message for the target SN, if received from the UE. |
| 7. | If configured with bearers requiring SCG radio resources the UE synchronizes to the |
| | target SN. |
| 8. | If PDCP termination point is changed for bearers using RLC AM, the source SN sends |
| | the SN Status Transfer, which the MN sends then to the target SN, if needed. |
| 9. | If applicable, data forwarding from the source SN takes place. It may be initiated as |
| | early as the source SN receives the SN Release Request message from the MN. |
| 10. | The source SN sends the Secondary RAT Data Usage Report message to the MN and |
| | includes the data volumes delivered to and received from the UE as described in clause |
| | 10.11.2. |
| NOTE 2: | The order the SN sends the Secondary RAT Data Usage Report message and |
| | performs data forwarding with MN is not defined. The SN may send the report |
| | when the transmission of the related QoS flow is stopped. |
| 11-15. | If applicable, a PDU Session path update procedure is triggered by the MN. |
| 16. | Upon reception of the UE Context Release message, the source SN releases radio and |
| | C-plane related resources associated to the UE context. Any ongoing data forwarding |
| | may continue |

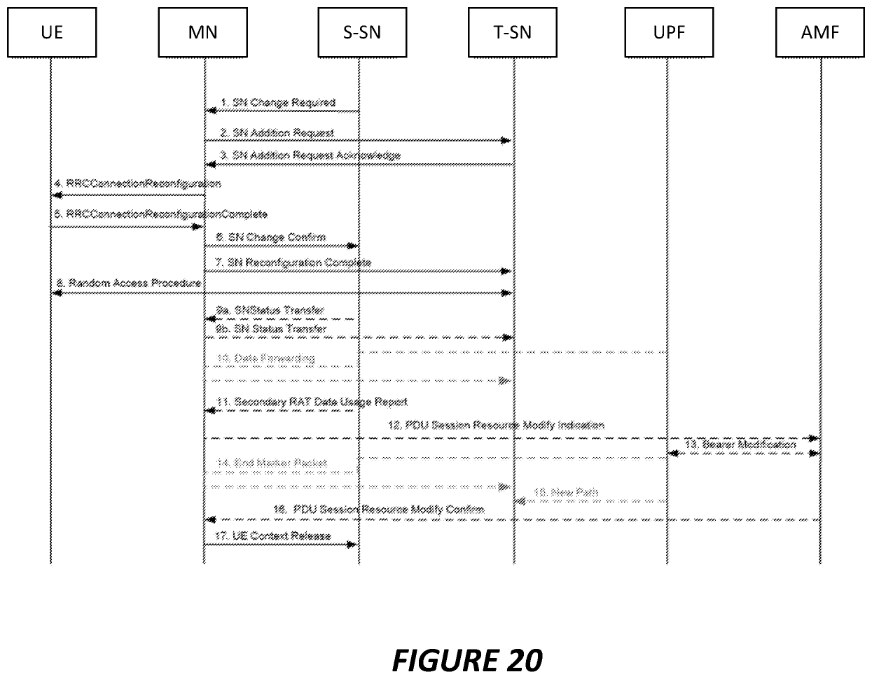

An example implementation of the embodiment that the SCG state for power saving is always set to SCG activated state, for the case of SN initiated SN mobility (when the SCG is deactivated) can be seen in Table 4 below, based on 3GPP TS 37.340 (v16.3.0), clause 10.5.2, where additions are marked as underlined text. FIG. 20 illustrates an example signaling flow for the SN change initiated by the SN according to some embodiments. Descriptions of each of the steps in the signaling flow diagram are also described below.

TABLE 4
Example Changes to 3GPP TS 37.340, clause 10.5.2

| | |
|---|---|
| 1. | The source SN initiates the SN change procedure by sending the SN Change Required |
| | message, which contains a candidate target node ID and may include the SCG |
| | configuration (to support delta configuration) and measurement results related to the |
| | target SN. |
| 2/3. | The MN requests the target SN to allocate resources for the UE by means of the SN |
| | Addition procedure, including the measurement results related to the target SN received |
| | from the source SN. If data forwarding is needed, the target SN provides data forwarding |
| | addresses to the MN. The target SN includes the indication of the full or delta RRC |
| | configuration. (Optionally) In case the SCG state for power saving is SCG deactivated |
| | state (and the target SN supports SCG state for power saving), the target SN includes a |
| | change to SCG activated state in the SCG configuration of the RRC configuration that |
| | is to be sent to the UE. Optionally the MN indicates to the target SN that the SCG state |
| | for power saving shall be SCG activated state. |
| 4/5. | The MN triggers the UE to apply the new configuration. The MN indicates the new |
| | configuration to the UE in the MN RRC reconfiguration message including the SN RRC |
| | reconfiguration message generated by the target SN. The UE applies the new |
| | configuration and sends the MN RRC reconfiguration complete message, including the |
| | SN RRC response message for the target SN, if needed. In case the UE is unable to |
| | comply with (part of) the configuration included in the MN RRC reconfiguration |
| | message, it performs the reconfiguration failure procedure. In case the SCG state for |
| | power saving was SCG deactivated state in the source SN the UE determines that the |
| | SCG state for power saving is changed to SCG activated state in the target SN. The |
| | MN determines that the SCG state for power saving is (changed to) SCG activated |
| | state. |
| 6. | If the allocation of target SN resources was successful, the MN confirms the change of |
| | the source SN. If data forwarding is needed the MN provides data forwarding addresses |
| | to the source SN. If direct data forwarding is used for SN terminated bearers, the MN |
| | provides data forwarding addresses as received from the target SN to source SN. |
| | Reception of the SN Change Confirm message triggers the source SN to stop providing |
| | user data to the UE and, if applicable, to start data forwarding. |
| 7. | If the RRC connection reconfiguration procedure was successful, the MN informs the |
| | target SN via SN Reconfiguration Complete message with the included SN RRC |
| | response message for the target SN, if received from the UE. |
| 8. | The UE synchronizes to the target SN. |
| 9. | If PDCP termination point is changed for bearers using RLC AM, the source SN sends |
| | the SN Status Transfer, which the MN sends then to the target SN, if needed. |
| 10. | If applicable, data forwarding from the source SN takes place. It may be initiated as |
| | early as the source SN receives the SN Change Confirm message from the MN. |
| 11. | The source SN sends the Secondary RAT Data Usage Report message to the MN and |
| | includes the data volumes delivered to and received from the UE as described in clause |
| | 10.11.2. |
| NOTE 3: | The order the SN sends the Secondary RAT Data Usage Report message and |
| | performs data forwarding with MN/target SN is not defined. The SN may send the |
| | report when the transmission of the related QoS flow is stopped. |
| 12-16. | If applicable, a PDU Session path update procedure is triggered by the MN. |
| 17. | Upon reception of the UE Context Release message, the source SN |

releases radio and C-plane related resources associated to the UE context. Any ongoing data
forwarding may continue.

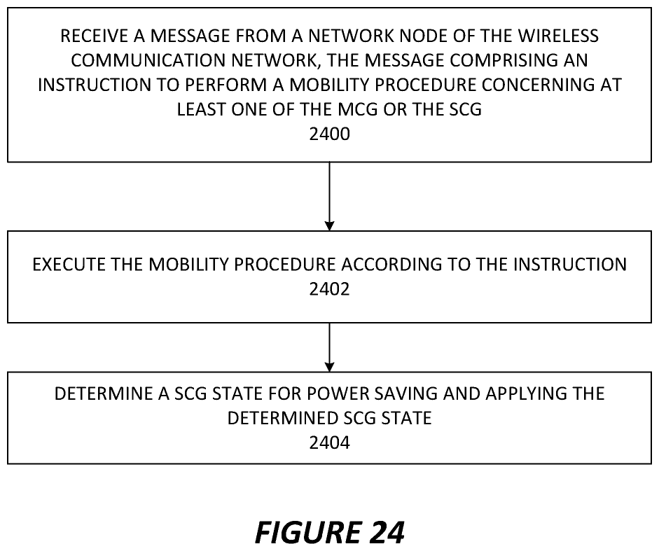

Operations of the communication device 300 (implemented using the structure of the block diagram of FIG. 21) will now be discussed with reference to the flow chart of FIG. 24 according to some embodiments of inventive concepts. For example, modules may be stored in memory 305 of FIG. 21, and these modules may provide instructions so that when the instructions of a module are executed by respective communication device processing circuitry 303, processing circuitry 303 performs respective operations of the flow chart.

FIG. 24 illustrates a method performed by a communication device operating in dual connectivity with a master cell group (MCG) and a secondary cell group (SCG) of a wireless communication network according to some embodiments of the present disclosure. For example, communication device 300 operates in dual connectivity with a MCG and a SCG of a wireless communication network. FIG. 24 illustrates the method includes receiving 2400 a message from a network node of the wireless communication network. The message comprises an instruction to perform a mobility procedure concerning at least one of the MCG or the SCG. Continuing the previous example, communication device 300 receives a message from, for example, RAN 400, of the wireless communication network. In some embodiments, the message comprises a Radio Resource Control (RRC) message. Additional examples and embodiments of the message comprising the instruction to perform the mobility procedure are described herein above with regards to FIGS. 14-23.

In some embodiments, the mobility procedure comprises MCG mobility from a source MCG, controlled by a source master node (MN), to a target MCG controlled by a target master node (MN). In some other embodiments, mobility procedure comprises SCG mobility from a source SCG controlled by a source secondary node (SN), to a target SCG controlled by a target secondary node (SN). Examples and additional embodiments of mobility procedure are discussed herein above with regards to FIGS. 14-23.

Returning to FIG. 24, the method also includes executing 2402 the mobility procedure according to the instruction. The method further includes determining 2404 a SCG state for power saving and applying the determined SCG state. Continuing the previous example, the communication device 300 executes the mobility procedure according to the instruction. The communication device 300 also determines and applies the SCG state for power saving. In some embodiments, the method includes determining an SCG activated state in response to execution of an MCG mobility procedure or an SCG mobility procedure. In some other embodiments, the method includes determining the SCG state for power saving based on a determination that the mobility procedure is to remain the same as before the mobility procedure was activated. Additional examples and embodiments with regards to determination of the SCG state are described herein above with regards to FIGS. 14-23.

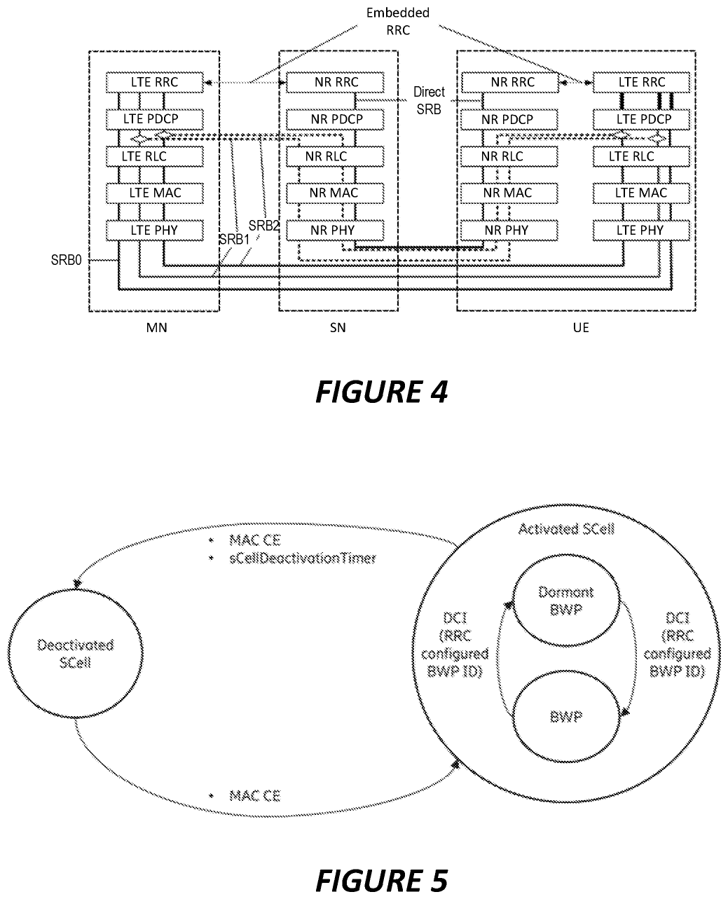

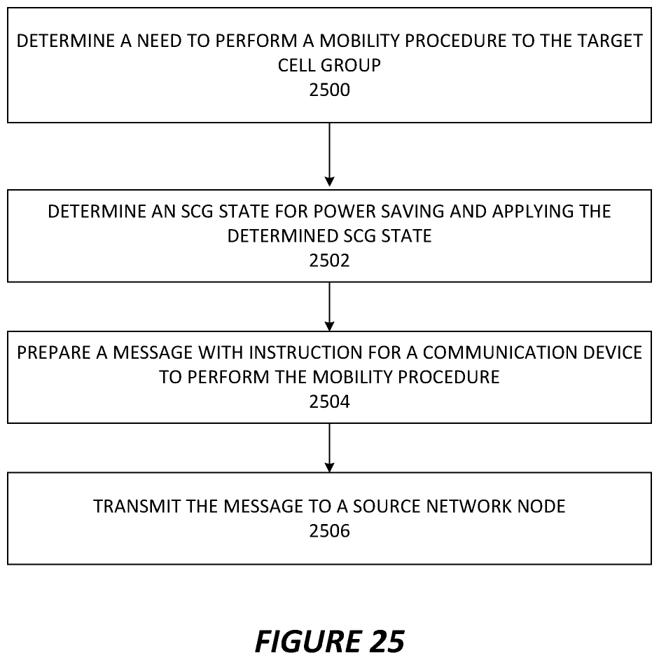

Operations of a RAN node 400 (implemented using the structure of FIG. 22) will now be discussed with reference to the flow chart of FIGS. 25-27 according to some embodiments of inventive concepts. For example, modules may be stored in memory 405 of FIG. 4, and these modules may provide instructions so that when the instructions of a module are executed by respective RAN node processing circuitry 403, processing circuitry 403 performs respective operations of the flow chart.

FIG. 25 illustrates a method performed by a target network node configured to control a target cell group used by a communication device operating in dual connectivity with a master cell group (MCG) and a secondary cell group (SCG) of a wireless communication network according to some embodiments of the present disclosure. The method includes determining 2500 a need to perform a mobility procedure to the target cell group. For example, RAN 400 may comprise a target network node configured to control the target cell group used communication device 300 operating in dual connectivity with a MCG and a SCG of the wireless communication network. RAN 400 operates to determine a need to perform a mobility procedure to the target cell group in this example.

In some embodiments, the method includes determining the need to perform the mobility procedure to the target cell group based on a source network node initiating a mobility preparation procedure. In some other embodiments, the method includes determining the need to perform the mobility procedure to the target cell group based on when a third node triggers a mobility preparation procedure. In this embodiment, the third node comprises a master node. Additional examples and embodiments with regards to determining the need to perform the mobility procedure are discussed herein above with regards to FIGS. 14-23.

FIG. 25 also illustrates the method also includes determining 2502 an SCG state for power saving and applying the determined SCG state. Continuing the previous example, RAN 400 determines the SCG state for power saving and applies the determined SCG state. In some embodiments, the method includes determining an SCG activated state in response to execution of an MCG mobility procedure or an SCG mobility procedure. In some other embodiments, the method includes determining an SCG activated state in response to reception of a message from the communication device during the mobility procedure. The message from the communication device comprises an indication of the SCG state for power saving in one of a field or an information element of the message. Additional examples and embodiments with regards to a target network node determining and applying the SCG state are discussed herein above with regards to FIGS. 14-23.

Returning to FIG. 25, the method also includes preparing 2504 a message with instruction for a communication device to perform the mobility procedure and transmitting 2506 the message to a source network node. In some embodiments, the message comprises a Radio Resource Control (RRC) message. Additional examples and embodiments with regards to a target network node preparing the message with the instruction and transmitting the message to the communication device are discussed herein above with regards to FIGS. 14-23.

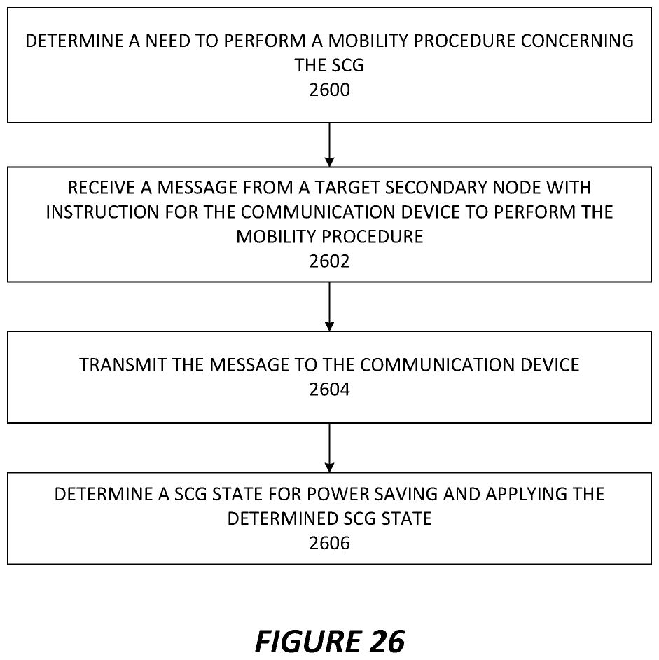

FIG. 26 illustrates a method performed by a master node (MN) controlling a master cell group (MCG) of a wireless communication network, the MN configured to communicate with a communication device operating in dual connectivity with the MCG and a secondary cell group (SCG) of a wireless communication network. FIG. 26 illustrates the method includes determining 2600 a need to perform a mobility procedure concerning the SCG. In some embodiments, the mobility procedure comprises SCG mobility from a source SCG controlled by a source secondary node (SN), to a target SCG controlled by a target secondary node (SN). For example, RAN 400 may comprise a MN controlling a MCG of a wireless network, in which RAN 400 communicates with communication device 300 operating in dual connectivity with the MCG and the SCG of the wireless communication network. In this example, RAN 400 determines a need to perform a mobility procedure concerning the SCG.

In some embodiments, the method includes determining the need to perform the mobility procedure concerning the SCG based on measurement reports received from the communication device. In some other embodiments, the method includes determining the need to perform the mobility procedure concerning the SCG when a third node triggers the mobility procedure. In some embodiments, the third node comprises a secondary node. Additional examples and embodiments with regards to the MN determining the need to perform the mobility procedure are discussed herein above with regards to FIGS. 14-23.

FIG. 26 also illustrates the method includes receiving 2602 a message from a target secondary node with instruction for the communication device to perform the mobility procedure. Continuing the previous example, RAN 400 receives a message from a target secondary node with instruction for communication device 300 to perform the mobility procedure. In some embodiments, the message comprises a Radio Resource Control (RRC) message. FIG. 26 also illustrates the method includes transmitting 2604 the message to the communication device. For example, RAN 400 transmits the message to communication device 300. Additional examples and embodiments with regards to the MN receiving and transmitting the message to the communication device are discussed herein above with regards to FIGS. 14-23.

The method further includes determining 2606 a SCG state for power saving and applying the determined SCG state as shown in FIG. 26. Continuing the previous example, RAN 400 determines a SCG state for power saving and applying the determined SCG state. In some embodiments, the method includes determining an SCG activated state in response to execution of the mobility procedure. In some embodiment, the method includes determining an SCG activated state in response to one of reception of a message from the communication device during the mobility procedure or an indication that the mobility procedure was initiated by one of the master node or the secondary node. In some embodiments, the indication is received from a target network node during the mobility procedure.

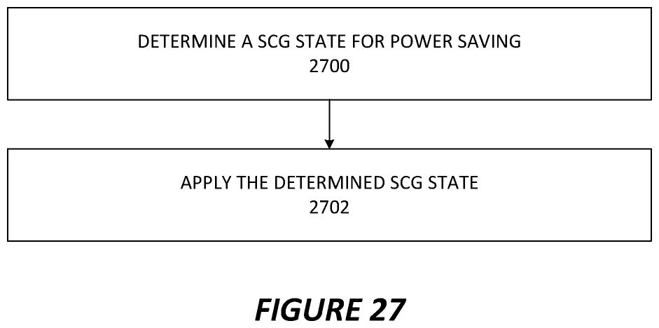

FIG. 27 illustrates a method performed by a secondary node (SN) controlling a secondary cell group (SCG) of a wireless communication network, the SN configured to communicate with a communication device operating in dual connectivity with the SCG and a master cell group (MCG) of a wireless communication network according to some embodiments of the present disclosure. FIG. 27 illustrates the method includes determining 2700 a SCG state for power saving and applying 2702 the determined SCG state. For example, RAN 400 may comprise a SN controlling a SCG of a wireless communication network. RAN 400 operating as an SN is configured to communicate with communication device 300 operating in dual connectivity with the SCG and a MCG of the wireless communication network. In this example, RAN 400 determines a SCG state for power saving and applies the determined SCG state.

In some embodiments, the method includes receiving a message from a network node during a mobility procedure concerning the MCG. In some embodiments, the network node comprises one of a source master node (MN) or a target MN. For example, RAN 400 receives a message from one of a source MN or target MN during a mobility procedure concerning the MCG. In some embodiments, the method includes determining the SCG state for power saving in response to receiving the message from the network node during the mobility procedure concerning the MCG. In some embodiments, the mobility procedure comprises MCG mobility from a source MCG controlled by a source master node (MN), to a target MCG controlled by a target master node (MN). In some embodiments, the message includes an indication of a SCG power state for power saving. In this embodiment, the method includes determining the SCG state based on the indication of the message. For example, RAN 400 determines the SCG state based on the indication of the message. In some other embodiments, the method includes determining an SCG activated state. Additional examples and embodiments with regards to the SN determining the SCG state are discussed above with regards to FIGS. 14-23.

In some other embodiments, the method includes receiving a message from the communication device indicating the communication device performs random access to the SN. For example, RAN 400 operating as an SN receives a message from communication device 300 indicating the communication device performs random access to the SN. In this embodiment the method includes determining the SCG state to be an SCG activated state based on the message from the communication device indicating the communication device performs random access to the SN. In this example, RAN 400 determines the SCG state to be an SCG activated state based on the message from communication device 300 indicating communication device 300 performs random access to the SN.

Additional example embodiments are discussed below.

1. A method, performed by a communication device operating in dual connectivity with a master cell group (MCG) and a secondary cell group (SCG) of a wireless communication network, the method comprising:
receiving a message from a network node of the wireless communication network, the message comprising an instruction to perform a mobility procedure concerning at least one of the MCG or the SCG;
executing the mobility procedure according to the instruction; and
determining a SCG state for power saving and applying the determined SCG state.

2. The method according to embodiment 1, wherein the message comprises a Radio Resource Control (RRC) message.

3. The method according to any one of embodiments 1-2, wherein the mobility procedure comprises MCG mobility from a source MCG, controlled by a source master node (MN), to a target MCG controlled by a target master node (MN).

4. The method according to any one of embodiments 1-2 wherein the mobility procedure comprises SCG mobility from a source SCG controlled by a source secondary node (SN), to a target SCG controlled by a target secondary node (SN).

5. The method according to any one of embodiments 1-4, wherein determining the SCG state for power saving comprises determining an SCG activated state in response to execution of an MCG mobility procedure or an SCG mobility procedure.

6. The method according to any one of embodiments 1-4, wherein determining the SCG state for power saving comprises determining the SCG state for power saving based on a determination that the mobility procedure is to remain the same as before the mobility procedure was activated.

7. A method, performed by a target network node configured to control a target cell group used by a communication device operating in dual connectivity with a master cell group (MCG) and a secondary cell group (SCG) of a wireless communication network, the method comprising:
determining a need to perform a mobility procedure to the target cell group;
determining an SCG state for power saving and applying the determined SCG state;
preparing a message with instruction for a communication device to perform the mobility procedure; and
transmitting the message to a source network node.

8. The method according to embodiment 7, wherein determining the need to perform the mobility procedure to the target cell group comprises determining the need to perform the mobility procedure to the target cell group based on a source network node initiating a mobility preparation procedure.

9. The method according to embodiment 7, wherein determining the need to perform the mobility procedure to the target cell group comprises determining the need to perform the mobility procedure to the target cell group based on when a third node triggers a mobility preparation procedure.

10. The method according to embodiment 9, wherein the third node comprises a master node.

11. The method according to any of embodiments 7-10, wherein the message comprises a Radio Resource Control (RRC) message.

12. The method according to any of embodiments 7-11, wherein determining the SCG state for power saving comprises determining an SCG activated state in response to execution of an MCG mobility procedure or an SCG mobility procedure.

13. The method according to any of embodiments 7-11, wherein determining the SCG state for power saving comprises determining an SCG activated state in response to reception of a message from the communication device during the mobility procedure.

14. The method according to any of embodiments 7-11 and 13, wherein the message from the communication device comprises an indication of the SCG state for power saving in one of a field or an information element of the message.

15. A method, performed by a master node (MN) controlling a master cell group (MCG) of a wireless communication network, the MN configured to communicate with a communication device operating in dual connectivity with the MCG and a secondary cell group (SCG) of a wireless communication network, the method comprising:
determining a need to perform a mobility procedure concerning the SCG;
receiving a message from a target secondary node with instruction for the communication device to perform the mobility procedure;
transmitting the message to the communication device; and
determining a SCG state for power saving and applying the determined SCG state.

16. The method according to embodiment 15, wherein the mobility procedure comprises SCG mobility from a source SCG controlled by a source secondary node (SN), to a target SCG controlled by a target secondary node (SN).

17. The method according to any one of embodiments 15-16, wherein determining the need to perform the mobility procedure comprises determining the need to perform the mobility procedure concerning the SCG based on measurement reports received from the communication device.

18. The method according to any one of embodiments 15-16, wherein determining the need to perform the mobility procedure comprises determining the need to perform the mobility procedure concerning the SCG when a third node triggers the mobility procedure.

19. The method according to embodiment 18, wherein the third node comprises a secondary node.

20. The method according to any of embodiments 15-19, wherein the message comprises a Radio Resource Control (RRC) message.

21. The method according to any of embodiments 15-20, wherein determining the SCG state for power saving comprises determining an SCG activated state in response to execution of the mobility procedure.

22. The method according to any of embodiments 15-20, wherein determining the SCG state for power saving comprises determining an SCG activated state in response to one of reception of a message from the communication device during the mobility procedure or an indication that the mobility procedure was initiated by one of the master node or the secondary node.

23. The method according to embodiment 22, wherein the indication is received from a target network node during the mobility procedure.

24. A method, performed by a secondary node (SN) controlling a secondary cell group (SCG) of a wireless communication network, the SN configured to communicate with a communication device operating in dual connectivity with the SCG and a master cell group (MCG) of a wireless communication network, the method comprising:
determining a SCG state for power saving; and
applying the determined SCG state.

25. The method according to embodiment 24, further comprising:
receiving a message from a network node during a mobility procedure concerning the MCG.

26. The method according to embodiments 24-25, wherein determining the SCG state comprises determining the SCG state for power saving in response to receiving the message from the network node during the mobility procedure concerning the MCG.

27. The method according to embodiment 26, wherein the network node comprises one of a source master node (MN) or a target MN.

28. The method according to any one of embodiments 24-27, wherein the mobility procedure comprises MCG mobility from a source MCG controlled by a source master node (MN), to a target MCG controlled by a target master node (MN).

29. The method according to any one of embodiments 24-28, wherein the message includes an indication of a SCG power state for power saving.

30. The method according to any one of embodiments 24-29, wherein determining the SCG state for power saving comprises determining the SCG state based on the indication of the message.

31. The method according to any of embodiments 24-28, wherein determining the SCG state for power saving comprises determining an SCG activated state.

32. The method according to embodiment 24, further comprising:
receiving a message from the communication device indicating the communication device performs random access to the SN.

33. The method according to embodiment 32, wherein determining the SCG state for power saving comprises determining the SCG state to be an SCG activated state based on the message from the communication device indicating the communication device performs random access to the SN.

34. A communication device (300) comprising:
processing circuitry (303); and
memory (305) coupled with the processing circuitry, wherein the memory includes instructions that when executed by the processing circuitry causes the communication device to perform operations according to any of Embodiments 1-6.

35. A communication device (300) adapted to perform according to any of Embodiments 1-6.

36. A computer program comprising program code to be executed by processing circuitry (303) of a communication device (300), whereby execution of the program code causes the communication device (300) to perform operations according to any of embodiments 1-6.

37. A computer program product comprising a non-transitory storage medium including program code to be executed by processing circuitry (303) of a communication device (300), whereby execution of the program code causes the communication device (300) to perform operations according to any of embodiments 1-6.

40. A radio access network, RAN, node (400) comprising:
processing circuitry (403); and
memory (405) coupled with the processing circuitry, wherein the memory includes instructions that when executed by the processing circuitry causes the RAN node to perform operations according to any of Embodiments 7-14.

41. A radio access network, RAN, node (400) adapted to perform according to any of Embodiments 7-14.

42. A computer program comprising program code to be executed by processing circuitry (403) of a radio access network, RAN, node (400), whereby execution of the program code causes the RAN node (400) to perform operations according to any of embodiments 7-14.

43. A computer program product comprising a non-transitory storage medium including program code to be executed by processing circuitry (403) of a radio access network, RAN, node (400), whereby execution of the program code causes the RAN node (400) to perform operations according to any of embodiments 7-14.

44. A radio access network, RAN, node (400) comprising:
processing circuitry (403); and
memory (405) coupled with the processing circuitry, wherein the memory includes instructions that when executed by the processing circuitry causes the RAN node to perform operations according to any of Embodiments 15-23.

45. A radio access network, RAN, node (400) adapted to perform according to any of Embodiments 15-23.

46. A computer program comprising program code to be executed by processing circuitry (403) of a radio access network, RAN, node (400), whereby execution of the program code causes the RAN node (400) to perform operations according to any of embodiments 15-23.

47. A computer program product comprising a non-transitory storage medium including program code to be executed by processing circuitry (403) of a radio access network, RAN, node (400), whereby execution of the program code causes the RAN node (400) to perform operations according to any of embodiments 15-23.

48. A radio access network, RAN, node (400) comprising:
processing circuitry (403); and
memory (405) coupled with the processing circuitry, wherein the memory includes instructions that when executed by the processing circuitry causes the RAN node to perform operations according to any of Embodiments 24-33.

49. A radio access network, RAN, node (400) adapted to perform according to any of Embodiments 24-33.

50. A computer program comprising program code to be executed by processing circuitry (403) of a radio access network, RAN, node (400), whereby execution of the program code causes the RAN node (400) to perform operations according to any of embodiments 24-33.

51. A computer program product comprising a non-transitory storage medium including program code to be executed by processing circuitry (403) of a radio access network, RAN, node (400), whereby execution of the program code causes the RAN node (400) to perform operations according to any of embodiments 24-33.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 28 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 28. For simplicity, the wireless network of FIG. 28 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 28, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 28 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 28 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

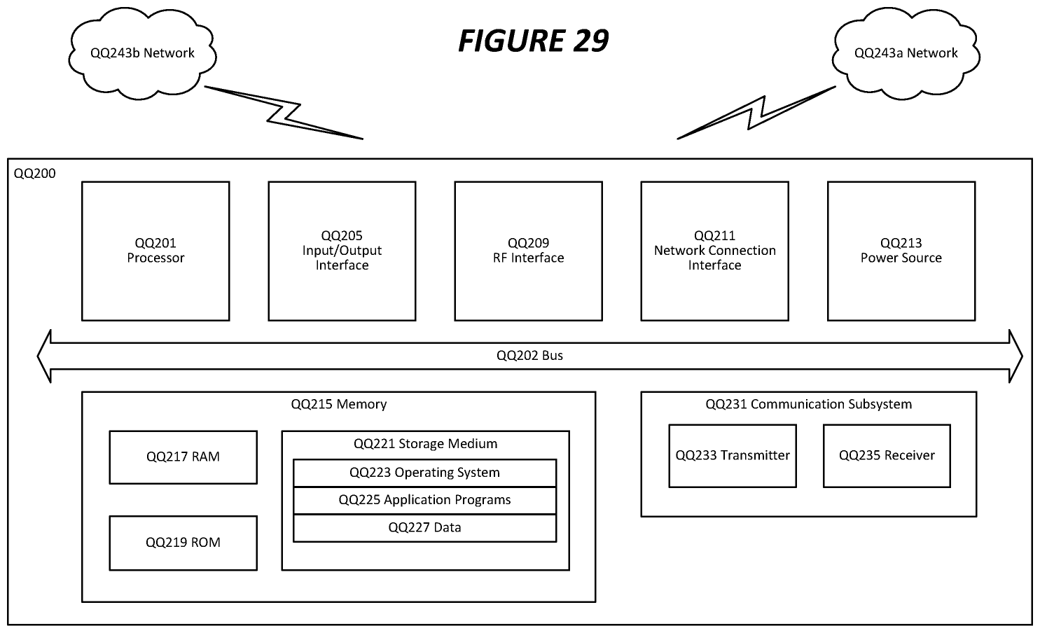

FIG. 29 illustrates a user Equipment in accordance with some embodiments.

FIG. 29 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 29, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 29 is a UE, the components discussed herein are equally applicable to a WD, and vice-versa.

In FIG. 29, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 29, or only a subset of the components. The level of integration between the components may vary from one UE to another UE. Further, certain UEs may contain multiple instances of a component, such as multiple processors, memories, transceivers, transmitters, receivers, etc.

In FIG. 29, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.) programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 29, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 29, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

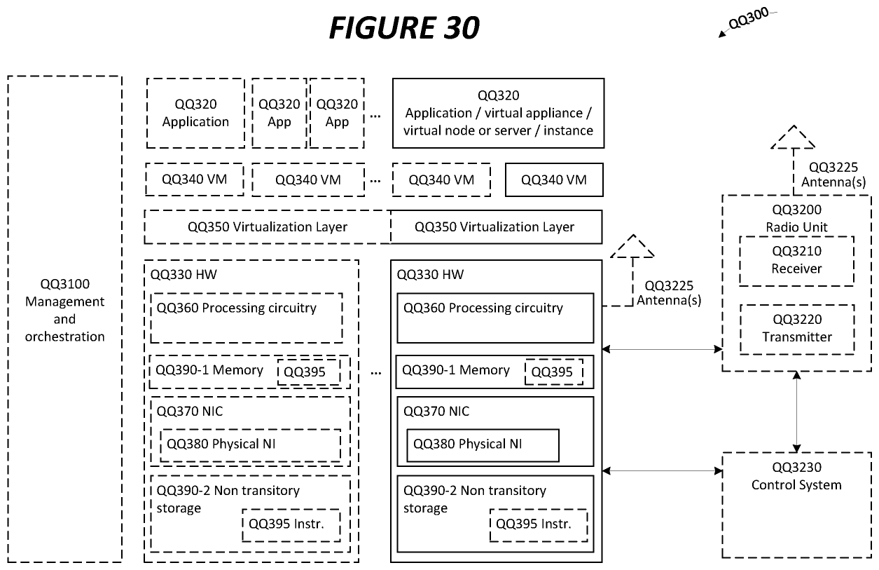

FIG. 30 illustrates a virtualization environment in accordance with some embodiments.

FIG. 30 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 30, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 30.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

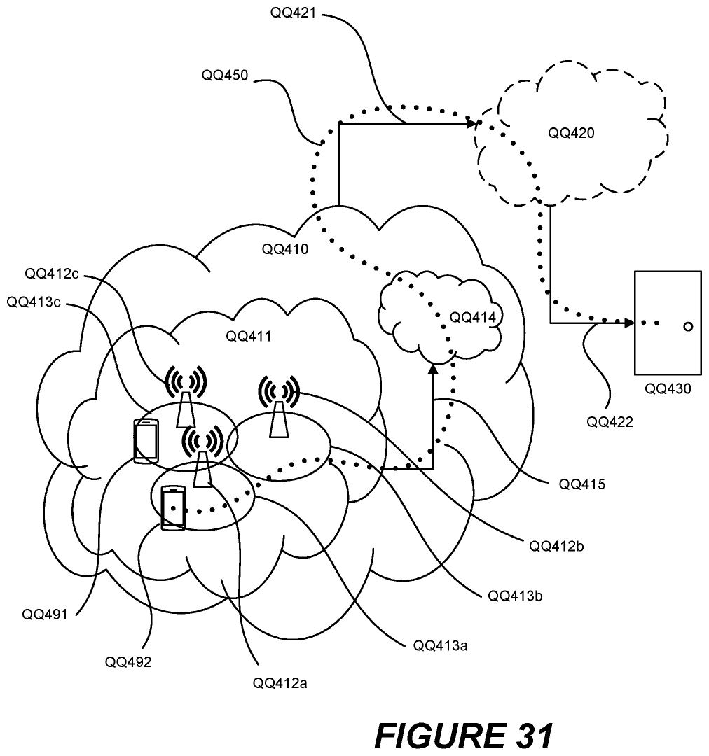

FIG. 31 illustrates a telecommunication network connected via an intermediate network to a host computer in accordance with some embodiments.

With reference to FIG. 31, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 31 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

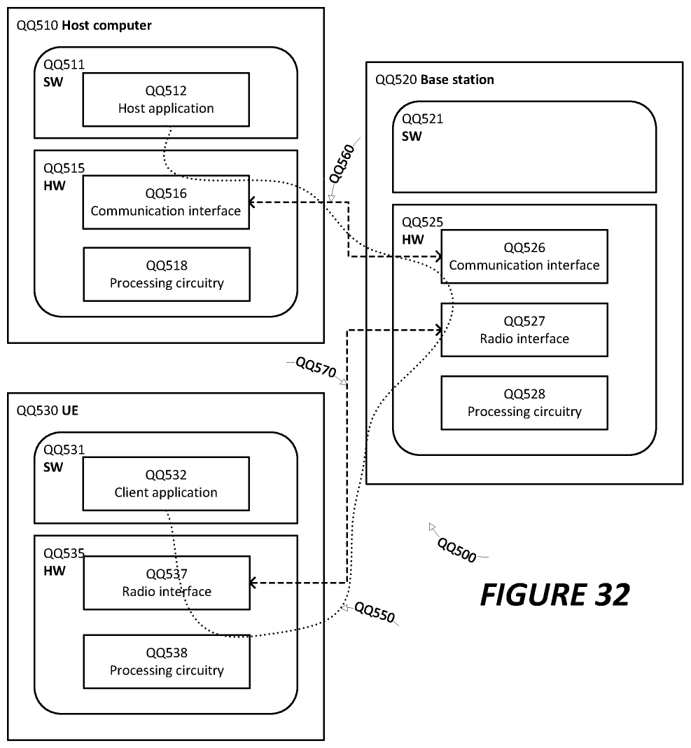

FIG. 32 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 32. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 32) served by base station 4520. Communication interface 4526 may be configured to facilitate connection 4560 to host computer 4510. Connection 4560 may be direct or it may pass through a core network (not shown in FIG. 32) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 32 may be similar or identical to host computer 4430, one of base stations 4412a, 4412b, 4412c and one of UEs 4491, 4492 of FIG. 31, respectively. This is to say, the inner workings of these entities may be as shown in FIG. 32 and independently, the surrounding network topology may be that of FIG. 31.

In FIG. 32, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

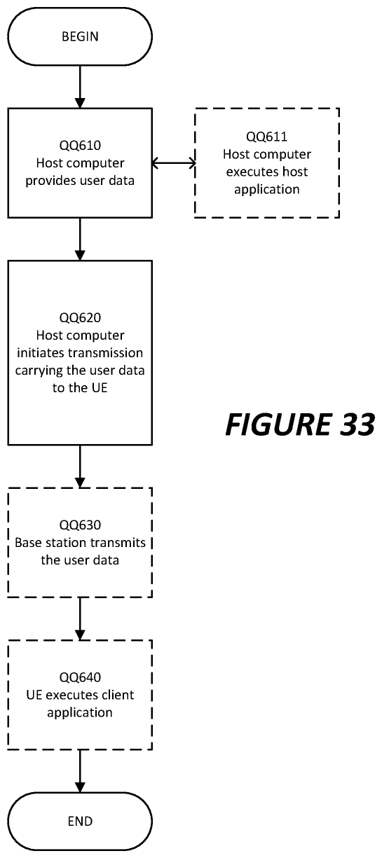

FIG. 33 illustrates methods implemented in a communication system including a host computer, a base station and a user equipment in accordance with some embodiments

FIG. 33 is a flowchart illustrating a method implemented in a communication system, in accordance with one embodiment. The communication system includes a host computer, a base station and a UE which may be those described with reference to FIGS. 31 and 32. For simplicity of the present disclosure, only drawing references to FIG. 33 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

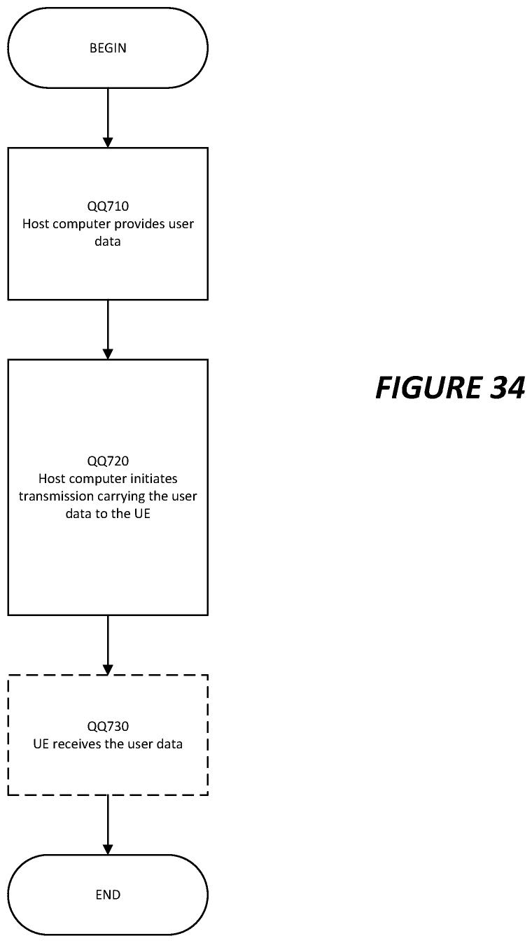

FIG. 34 illustrates methods implemented in a communication system including a host computer, a base station and a user equipment in accordance with some embodiments.

FIG. 34 is a flowchart illustrating a method implemented in a communication system, in accordance with one embodiment. The communication system includes a host computer, a base station and a UE which may be those described with reference to FIGS. 31 and 32. For simplicity of the present disclosure, only drawing references to FIG. 34 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

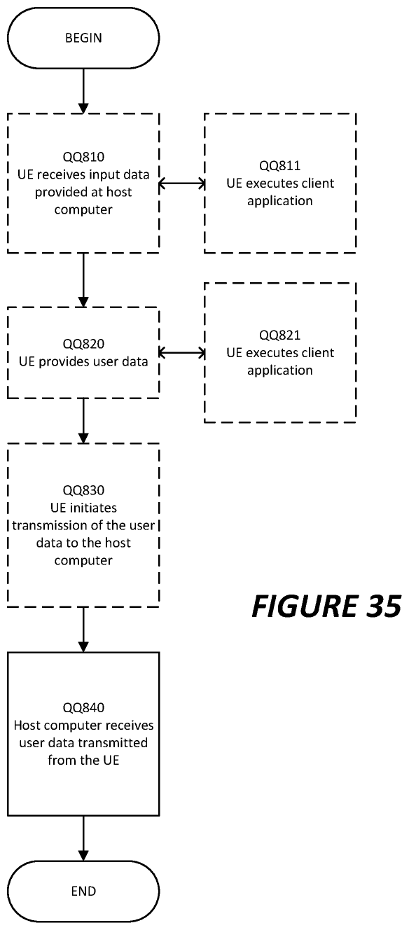

FIG. 35 illustrates methods implemented in a communication system including a host computer, a base station and a user equipment in accordance with some embodiments

FIG. 35 is a flowchart illustrating a method implemented in a communication system, in accordance with one embodiment. The communication system includes a host computer, a base station and a UE which may be those described with reference to FIGS. 31 and 32. For simplicity of the present disclosure, only drawing references to FIG. 35 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

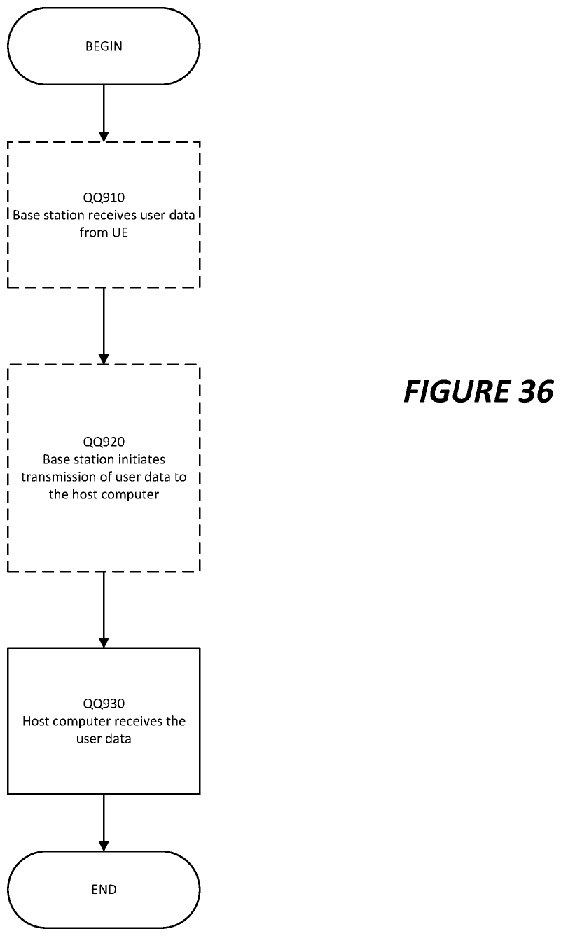

FIG. 36 illustrates methods implemented in a communication system including a host computer, a base station and a user equipment in accordance with some embodiments

FIG. 36 is a flowchart illustrating a method implemented in a communication system, in accordance with one embodiment. The communication system includes a host computer, a base station and a UE which may be those described with reference to FIGS. 31 and 32. For simplicity of the present disclosure, only drawing references to FIG. 36 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

### Abbreviation Explanation

1×RTT CDMA2000 1× Radio Transmission Technology
3GPP 3rd Generation Partnership Project
5G 5th Generation
5GCN 5G core network
ABS Almost Blank Subframe
ACK Acknowledgement
AGC Automatic Gain Control
AMF Access and Mobility management Function
AP Application Protocol
ARQ Automatic Repeat Request
AWGN Additive White Gaussian Noise
BCCH Broadcast Control Channel
BCH Broadcast Channel
BSR Buffer Status Report
BWP Bandwidth Part
CA Carrier Aggregation
CA Carrier Aggregation
CC Component Carrier
CCCH SDU Common Control Channel SDU
CDMA Code Division Multiplexing Access
CE Control Element
CGI Cell Global Identifier
CHO Conditional Handover
CIR Channel Impulse Response
CN Core Network
CP Cyclic Prefix
CP Control Plane
CPA Conditional PSCell Addition
CPC Conditional PSCell Change
CPICH Common Pilot Channel
CQI Channel Quality information
C-RNTI Cell Radio Network Temporary Identifier
CSI Channel State Information
DC Dual Connectivity
DCCH Dedicated Control Channel
DCI Downlink Control Information
DL Downlink
DM Demodulation
DMRS Demodulation Reference Signal
DRB Data Radio Bearer
DRX Discontinuous Reception
DTCH Dedicated Traffic Channel
DTX Discontinuous Transmission
DUT Device Under Test
ECGI Evolved CGI
E-CID Enhanced Cell-ID (positioning method)
eNB E-UTRAN NodeB
ePDCCH enhanced Physical Downlink Control Channel
E-RAB EUTRAN Radio Access Bearer
E-SMLC Evolved-Serving Mobile Location Centre
E-UTRA Evolved Universal Terrestrial Radio Access
E-UTRAN Evolved Universal Terrestrial Radio Access Network
FDD Frequency Division Duplex
FDD Frequency Division Duplex
FFS For Further Study
GERAN GSM EDGE Radio Access Network
gNB Base station in NR
GNSS Global Navigation Satellite System
GSM Global System for Mobile communication
GTP-U GPRS Tunneling Protocol—User Plane
HARQ Hybrid Automatic Repeat Request
HO Handover
HRPD High Rate Packet Data
HSPA High Speed Packet Access
IE Information Element
IP Internet Protocol
LOS Line of Sight
LPP LTE Positioning Protocol
LTE Long-Term Evolution
MAC Medium Access Control
MAC CE MAC Control Element
MBMS Multimedia Broadcast Multicast Services
MBSFN Multimedia Broadcast multicast service Single Frequency Network
MBSFN ABS MBSFN Almost Blank Subframe
MCG Master Cell Group
MDT Minimization of Drive Tests
MeNB Master eNB
MgNB Master gNB
MIB Master Information Block
MME Mobility Management Entity
MN Master Node
MR-DC Multi-Radio Dual Connectivity
MSC Mobile Switching Center
NACK Negative Acknowledgement
NAS Non Access Stratum
NG Next Generation Evolved Node B
NG-RAN Next Generation Radio Access Network
NPDCCH Narrowband Physical Downlink Control Channel
NR New Radio
O&M Operation and Maintenance
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
PBCH Physical Broadcast Channel
P-CCPCH Primary Common Control Physical Channel
PCell Primary Cell
PCFICH Physical Control Format Indicator Channel
PCI Physical Cell Identity
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSCell Primary Secondary Cell (in LTE) or Primary SCG Cell (in NR
PSS Primary Synchronization Signal
PUCCH Physical Uplink Control Channel
PUSCH Physical Uplink Shared Channel
QAM Quadrature Amplitude Modulation
RACH Random Access Channel
RAN Radio Access Network
RAT Radio Access Technology
RB Radio Bearer
RLC Radio Link Control
RLF Radio Link Failure
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
RSRQ Reference Signal Received Quality OR
RSSI Received Signal Strength Indicator
RSTD Reference Signal Time Difference
SCell Secondary Cell
SCG Secondary Cell Group
SCH Synchronization Channel
SCTP Stream Control Transmission Protocol
SDU Service Data Unit
SeNB Secondary eNB
SFN System Frame Number
SgNB Secondary gNB
SGW Serving Gateway
SI System Information
SIB System Information Block
SINR Signal to Interference plus Noise Ratio
SN Secondary Node
SNR Signal to Noise Ratio
SON Self Optimized Network
SR Scheduling Request
SRB Signaling Radio Bearer
SS Synchronization Signal
S-SN Source Secondary Node
SSS Secondary Synchronization Signal
SUL Supplementary uplink
TDD Time Division Duplex
TDOA Time Difference of Arrival
TEID Tunnel Endpoint IDentifier
TNL Transport Network Layer
TOA Time of Arrival
T-SN Target Secondary Node
TSS Tertiary Synchronization Signal
TTI Transmission Time Interval
UCI Uplink Control Information
UDP User Datagram Protocol
UE User Equipment
UL Uplink
UMTS Universal Mobile Telecommunication System
UP User Plane
UPF User Plane Function
URLLC Ultra Reliable Low Latency Communication
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network
X2 Interface between base stations

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method, performed by a communication device operating in dual connectivity with a master cell group, MCG, and a secondary cell group, SCG, of a wireless communication network, the method comprising:
receiving a message from a network node of the wireless communication network, the message comprising an instruction to perform a mobility procedure concerning at least one of the MCG or the SCG;
determining an SCG state for power saving for the communication device;
executing the mobility procedure according to the instruction and according to the determined SCG state for power saving; and
applying the determined SCG state for power saving following execution of the mobility procedure.

2. The method according to claim 1, wherein the message comprises a Radio Resource Control, RRC, message.

3. The method of claim 1, wherein in response to determining that the SCG state for power saving is an SCG activated state, the communication device performs a random access to a target cell.

4-5. (canceled)

6. The method according to any claim 1, wherein determining the SCG state is based on an SCG state indication message from a network node of the wireless communication network, the message comprising an instruction to perform a mobility procedure.

7. A method, performed by a target network node configured to control a target cell group used by a communication device operating in dual connectivity with a master cell group, MCG, and a secondary cell group, SCG, of a wireless communication network, the method comprising:
determining a need of the communication device to perform a mobility procedure to the target cell group;
determining an SCG state for power saving for the communication device;
preparing a message with an instruction for a communication device to perform the mobility procedure; and
transmitting the message to a source network node.

8. The method of claim 7, wherein the message comprises an indication of the SCG state for power saving.

9. The method according to claim 7, wherein determining the need to perform the mobility procedure to the target cell group comprises determining the need to perform the mobility procedure to the target cell group based on a source network node initiating a mobility preparation procedure.

10-13. (canceled)

14. The method according to claim 7, wherein the message from the communication device comprises an indication of the SCG state for power saving in one of a field or an information element of the message.

15. A method, performed by a master node, MN, controlling a master cell group, MCG, of a wireless communication network, the MN configured to communicate with a communication device operating in dual connectivity with the MCG and with a secondary cell group, SCG, of a wireless communication network, the method comprising:
determining a need for the communication device to perform a mobility procedure concerning the SCG;
receiving a message from a target secondary node with an instruction for the communication device to perform the mobility procedure;
transmitting the message to the communication device;
determining an SCG state for power saving for the communication device; and
applying the determined SCG state.

16. The method according to claim 15, wherein the mobility procedure comprises SCG mobility from a source SCG controlled by a source secondary node, SN, to a target SCG controlled by a target secondary node, SN.

17. The method according to claim 15, wherein determining the need for the communication device to perform the mobility procedure comprises determining the need for the communication device to perform the mobility procedure concerning the SCG based on measurement reports received from the communication device.

18. The method according to claim 15, wherein determining the need for the communication device to perform the mobility procedure comprises determining the need for the communication device to perform the mobility procedure concerning the SCG when a third node triggers the mobility procedure.

19. The method according to claim 18, wherein the third node comprises a secondary node.

20. The method according to claim 15, wherein the message comprises a Radio Resource Control, RRC, message.

21. (canceled)

22. The method according to claim 15, wherein determining the SCG state for power saving for the communication device comprises determining an SCG activated state for the communication device in response to one of reception of a message from the communication device during the mobility procedure or an indication that the mobility procedure was initiated by one of the master node or the secondary node.

23. The method according to claim 22, wherein the indication is received from a target network node during the mobility procedure.

24. A method, performed by a secondary node, SN, controlling a secondary cell group, SCG, of a wireless communication network, the SN configured to communicate with a communication device operating in dual connectivity with the SCG and a master cell group, MCG, of a wireless communication network, the method comprising:
determining an SCG state for power saving for the communication device in connection with a mobility procedure involving the communication device; and
applying the determined SCG state for power saving for the communication device.

25. The method according to claim 24, wherein the mobility procedure is concerning the MCG, the method further comprising:
receiving a message from a network node during the mobility procedure concerning the MCG.

26. The method according to claim 25, wherein determining the SCG state for power saving comprises determining the SCG state for power saving in response to receiving the message from the network node during the mobility procedure concerning the MCG.

27. The method according to claim 26, wherein the network node comprises one of a source master node, MN, or a target MN.

28. The method according to claim 24, wherein the mobility procedure comprises MCG mobility from a source MCG controlled by a source master node, MN, to a target MCG controlled by a target master node, MN.

29. The method according to claim 24, wherein the message includes an indication of a SCG power state for power saving.

30. The method according to claim 24, wherein determining the SCG state for power saving comprises determining the SCG state based on the indication of the message.

31. The method according to claim 24, wherein determining the SCG state for power saving comprises determining an SCG activated state.

32. The method according to claim 24, further comprising:
receiving a message from the communication device indicating the communication device performs random access to the SN.

33. The method according to claim 32, wherein determining the SCG state for power saving comprises determining the SCG state to be an SCG activated state based on the message from the communication device indicating the communication device performs random access to the SN.

34-49. (canceled)
